(19) United States
(12) Patent Application Publication
(10) Pub. No.: US 2025/0031134 A1
(43) Pub. Date: Jan. 23, 2025

(54) ACQUISITION OF SYSTEM INFORMATION

(71) Applicant: Samsung Electronics Co., Ltd., Suwon-si (KR)

(72) Inventors: Anil Agiwal, Allen, TX (US); Kyeongin Jeong, Allen, TX (US); Hongbo Si, Allen, TX (US)

(21) Appl. No.: 18/764,061

(22) Filed: Jul. 3, 2024

Related U.S. Application Data
(60) Provisional application No. 63/527,977, filed on Jul. 20, 2023.
(60) Provisional application No. 63/528,818, filed on Jul. 25, 2023.
(60) Provisional application No. 63/536,282, filed on Sep. 1, 2023.

(51) Int. Cl. H04W 48/14; H04W 48/12

(52) U.S. Cl. CPC H04W 48/14; H04W 48/12

(57) ABSTRACT

A UE includes a processor, and a transceiver operatively coupled to the processor. The transceiver is configured to receive information indicating that a system information block 1 (SIB1) for a cell is not periodically broadcast within the cell, transmit, based on the information, a request for the SIB1 of the cell, and receive the SIB1 of the cell.

### CROSS-REFERENCE TO RELATED APPLICATION(S) AND CLAIM OF PRIORITY

This application claims priority under 35 U.S.C. § 119 (e) to U.S. Provisional Patent Application No. 63/527,977 filed on Jul. 20, 2023, U.S. Provisional Patent Application No. 63/528,818 filed on Jul. 25, 2023, and U.S. Provisional Patent Application No. 63/536,282 filed on Sep. 1, 2023. The above-identified provisional patent applications are hereby incorporated by reference in their entirety.

### TECHNICAL FIELD

This disclosure relates generally to wireless networks. More specifically, this disclosure relates to acquisition of system information.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for acquisition of system information.

In one embodiment, a user equipment (UE) is provided. The UE includes a processor, and a transceiver operatively coupled to the processor. The transceiver is configured to receive information indicating that a system information block 1 (SIB1) for a cell is not periodically broadcast within the cell, transmit, based on the information, a request for the SIB1 of the cell, and receive the SIB1 of the cell.

In another embodiment, a base station (BS) is provided. The BS includes a processor, and a transceiver operatively coupled to the processor. The transceiver is configured to transmit information indicating that a SIB1 for a cell is not periodically broadcast within the cell, receive a request for the SIB1 of the cell, and transmit the SIB1 of the cell.

In yet another embodiment, a method of operating a UE is provided. The method includes receiving information indicating that a system information block 1 (SIB1) for a cell is not periodically broadcast within the cell, and transmitting, based on the information, a request for the SIB1 of the cell. The method further includes receiving the SIB1 of the cell.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of this disclosure;

FIG. 3A illustrates an example UE according to embodiments of the present disclosure;

FIG. 3B illustrates an example gNB according to embodiments of the present disclosure;

FIG. 4 illustrates an example of a Cell DTX cycle configuration in a cell according to embodiments of the present disclosure;

FIG. 5 illustrates an example network operation during the Cell DTX cycle according to embodiments of the present disclosure;

FIG. 6 illustrates an example UE operation during a Cell DTX cycle according to embodiments of the present disclosure;

FIG. 7 illustrates an example of PO monitoring according to embodiments of the present disclosure;

FIG. 8 illustrates another example of PO monitoring according to embodiments of the present disclosure;

FIG. 9 illustrates another example of PO monitoring according to embodiments of the present disclosure;

FIG. 10 illustrates an example UE operation to acquire SIB1 in a cell according to embodiments of the present disclosure;

FIG. 11 illustrates another example UE operation to acquire SIB1 in a cell according to embodiments of the present disclosure;

FIG. 12 illustrates another example UE operation to acquire SIB1 in a cell according to embodiments of the present disclosure;

FIG. 13 illustrates another example UE operation to acquire SIB1 in a cell according to embodiments of the present disclosure;

FIG. 14 illustrates another example UE operation to acquire SIB1 in a cell according to embodiments of the present disclosure;

FIG. 15 illustrates another example UE operation to acquire SIB1 in a cell according to embodiments of the present disclosure;

FIG. 16 illustrates an example UE operation to acquire SIB1 and/or a MIB/SSB during a non-active duration in a cell according to embodiments of the present disclosure;

FIG. 17 illustrates an example UE operation to acquire SIB1 and/or a MIB/SSB according to embodiments of the present disclosure;

FIG. 18 illustrates an example UE operation to acquire on demand SSBs/light MIB in a cell according to embodiments of the present disclosure;

FIG. 19 illustrates an example UE operation for RRC connection resumption 1900 according to embodiments of the present disclosure;

FIG. 20 illustrates another example UE operation for RRC connection resumption according to embodiments of the present disclosure;

FIG. 21 illustrates another example UE operation for RRC connection resumption according to embodiments of the present disclosure; and

FIG. 22 illustrates an example method for acquisition of system information according to embodiments of the present disclosure.

### DETAILED DESCRIPTION

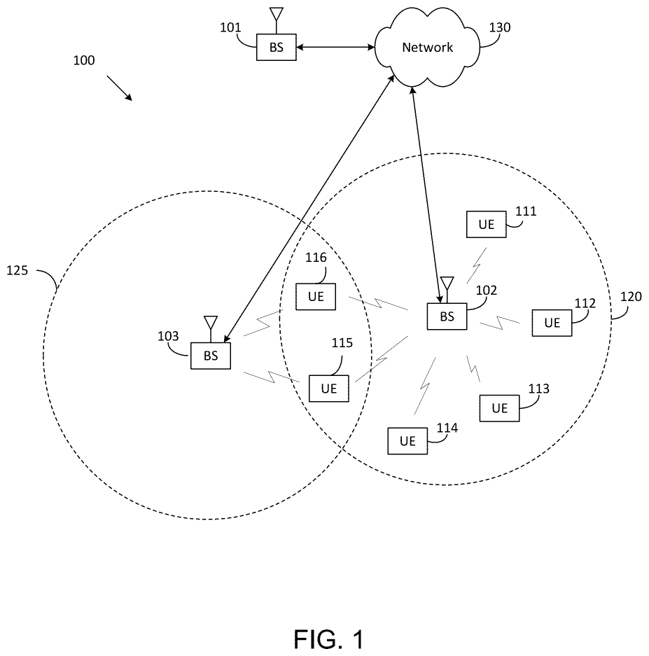

FIGS. 1 through 22, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for acquisition of system information. In certain embodiments, one or more of the gNBs 101-103 includes circuitry, programing, or a combination thereof, to support acquisition of system information in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

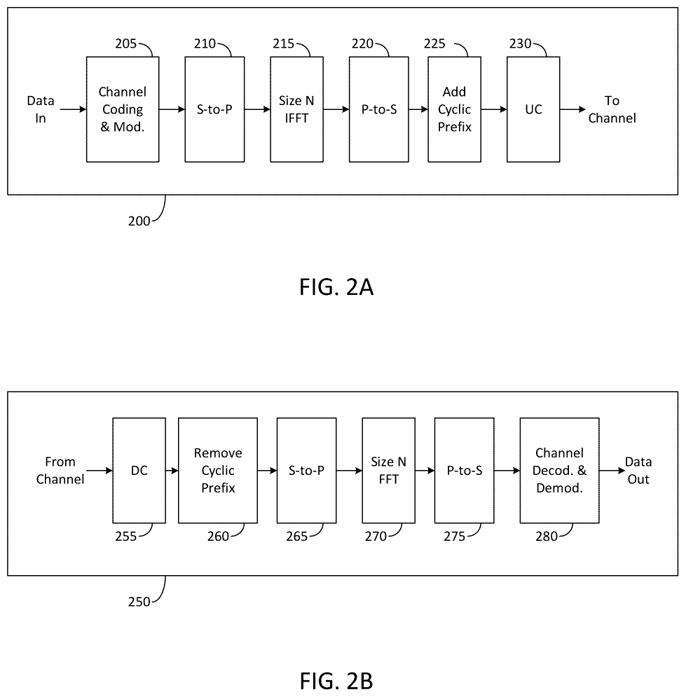

FIGS. 2A and 2B illustrate example wireless transmit and receive paths according to embodiments of this disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support acquisition of system information as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

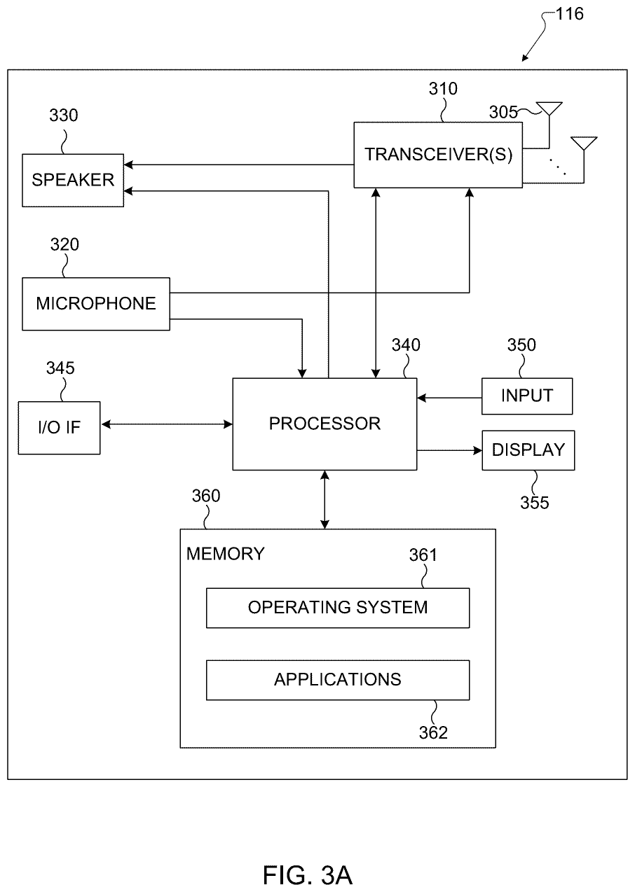

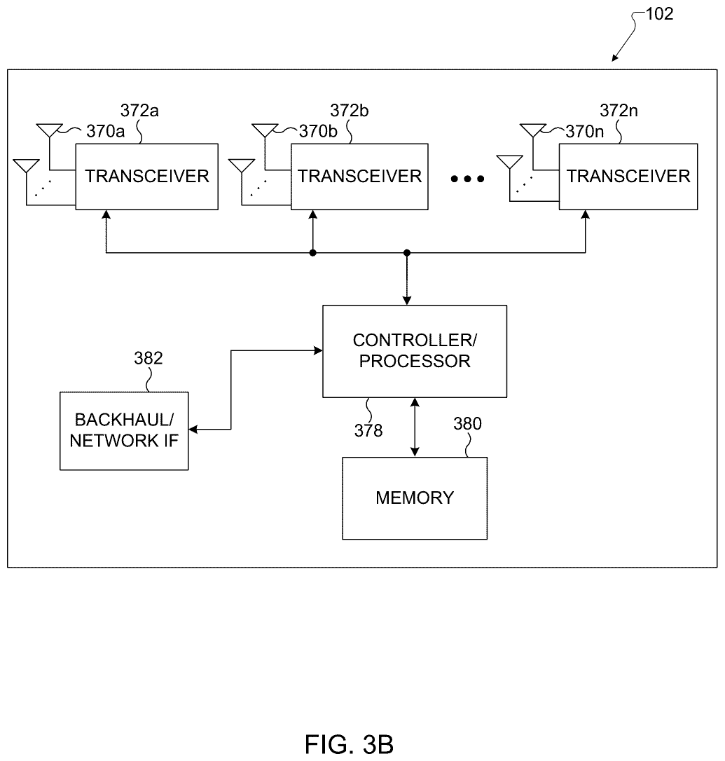

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for acquisition of system information as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support acquisition of system information as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The next generation wireless communication system (e.g., 5G, beyond 5G (B5G), 6G) supports not only lower frequency bands but also higher frequency (mmWave, tera hertz) bands (e.g., 10 GHz to 100 GHz bands), so as to accomplish higher data rates. To mitigate propagation loss of the radio waves and increase the transmission distance, beamforming, massive Multiple-Input Multiple-Output (MIMO), Full Dimensional MIMO (FD-MIMO), array antenna, analog beam forming, and large-scale antenna techniques are being considered in the design of the fifth-generation wireless communication system. In addition, the next generation wireless communication system is expected to address different use cases having quite different requirements in terms of data rate, latency, reliability, mobility etc. However, it is expected that the design of the air-interface of the next-generation wireless communication system would be flexible enough to serve UEs having quite different capabilities depending on the use case and market segment the UE caters to service the end customer. A few example use cases the next-generation wireless communication system wireless system is expected to address are enhanced Mobile Broadband (eMBB), massive Machine Type Communication (m-MTC), ultra-reliable low latency communication (URLL) etc. The eMBB requirements like tens of Gbps data rate, low latency, high mobility, etc., address the market segment representing the conventional wireless broadband subscribers needing internet connectivity everywhere, all the time and on the go. The m-MTC requirements like very high connection density, infrequent data transmission, very long battery life, low mobility, etc., address the market segment representing the Internet of Things (IoT)/Internet of Everything (IoE) envisioning connectivity of billions of devices. The URLL requirements like very low latency, very high reliability, variable mobility, etc., address the market segment representing Industrial automation applications, vehicle-to-vehicle/vehicle-to-infrastructure communication (foreseen as one of the enablers for autonomous cars), etc.

In the next generation wireless communication system (e.g., 5G, beyond 5G (B5G), 6G) operating in higher frequency (mmWave) bands, the UE and gNB communicate with each other using beamforming. Beamforming techniques are used to mitigate propagation path losses and to increase the propagation distance for communication at the higher frequency band. Beamforming enhances the transmission and reception performance using a high-gain antenna. Beamforming can be classified into Transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred as a transmit (TX) beam. A wireless communication system operating at high frequency uses a plurality of narrow TX beams to transmit signals in the cell, as each narrow TX beam provides coverage to a part of cell. The narrower the TX beam, the higher the antenna gain and hence the higher the propagation distance of a signal transmitted using beamforming. A receiver can also generate a plurality of receive (RX) beam patterns of different directions. Each of these receive patterns can be also referred as a receive (RX) beam.

The next generation wireless communication system supports standalone modes of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with CA/DC there is only one serving cell comprising the primary cell. For a UE in an RRC_CONNECTED state configured with CA/DC the term ‘serving cells’ is used to denote the set of cells comprising the Special Cell(s) and all secondary cells. In NR the term Master Cell Group (MCG) refers to a group of serving cells associated with the Master Node, comprising the PCell and optionally one or more SCells. In NR the term Secondary Cell Group (SCG) refers to a group of serving cells associated with the Secondary Node, comprising the PSCell and optionally one or more SCells. In NR the term PCell (primary cell) refers to a serving cell in a MCG, operating on the primary frequency, in which the UE either performs the initial connection establishment procedure or initiates the connection re-establishment procedure. In NR for a UE configured with CA, a Scell is a cell providing additional radio resources on top of Special Cell. Primary SCG Cell (PSCell) refers to a serving cell in SCG in which the UE performs random access when performing the Reconfiguration with Sync procedure. For Dual Connectivity operation the term SpCell (i.e., Special Cell) refers to the PCell of the MCG or the PSCell of the SCG, otherwise the term Special Cell refers to the PCell.

In the next generation wireless communication system, a node B (gNB) or base station in cell broadcast Synchronization Signal and PBCH block, also referred to as a Synchronization Signal Block (SSB), comprises primary and secondary synchronization signals (PSS, SSS) and system information. System information includes common parameters needed to communicate in a cell. In the next generation wireless communication system (also referred as next generation radio or NR), System Information (SI) is divided into the MIB and a number of SIBs where: The MIB is transmitted on the BCH with a periodicity of 80 ms and repetitions made within 80 ms and it includes parameters that are needed to acquire SIB1 from the cell. The SIB1 is transmitted on the DL-SCH with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to an SI message, periodicity, SI-window size) of other SIBs with an indication whether one or more SIBs are only provided on-demand, and, in that case, the configuration needed by the UE to perform the SI request. SIB1 is a cell-specific SIB; SIBs other than SIB1 and posSIBs are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with same length for all SI messages). Each SI message is associated with an SI-window and the SI-windows of different SI messages do not overlap. That is, within one SI-window only the corresponding SI message is transmitted. An SI message may be transmitted a number of times within the SI-window. Any SIB or posSIB except SIB1 can be configured to be cell specific or area specific, using an indication in SIB1. The cell specific SIB is applicable only within a cell that provides the SIB while the area specific SIB is applicable within an area referred to as SI area, which comprises one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using the RRCReconfiguration message, e.g., if the UE has an active BWP with no common search space configured to monitor system information, paging, or upon request from the UE. In the RRC_CONNECTED state, the UE acquires the required SIB(s) from the PCell. For a PSCell and SCells, the network provides the required SI by dedicated signaling, i.e., within an RRCReconfiguration message. Nevertheless, the UE acquires the MIB of the PSCell to get SFN timing of the SCG (which may be different from MCG). Upon change of relevant SI for the SCell, the network releases and adds the concerned SCell. For PSCell, the required SI can only be changed with Reconfiguration with Sync.

In the next generation wireless communication system, random access (RA) is supported. Random access (RA) is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by a non-synchronized UE in an RRC CONNECTED state. Several types of random-access procedures are supported such as contention based random access, contention free random access and each of these can be one of 2 step or 4 step random access.

In the next generation wireless communication system, a Physical Downlink Control Channel (PDCCH) is used to schedule DL transmissions on PDSCH and UL transmissions on PUSCH, where the Downlink Control Information (DCI) on the PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the PRB(s) and OFDM symbol(s) where the UE may assume no transmission is intended for the UE; transmission of TPC commands for PUCCH and PUSCH; transmission of one or more TPC commands for SRS transmissions by one or more UEs; switching a UE's active bandwidth part; and initiating a random access procedure. A UE monitors a set of PDCCH candidates in the configured monitoring occasions in one or more configured COntrol REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE comprising a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own DMRS. QPSK modulation is used for PDCCH.

In the next generation wireless communication system (e.g., 5G), a list of search space configurations is signaled by a gNB for each configured BWP of a serving cell, wherein each search configuration is uniquely identified by a search space identifier. The search space identifier is unique amongst the BWPs of a serving cell. An identifier of a search space configuration to be used for a specific purpose such as paging reception, SI reception, random access response reception is explicitly signaled by the gNB for each configured BWP. In NR, the search space configuration comprises parameters Monitoring-periodicity-PDCCH-slot, Monitoring-offset-PDCCH-slot, Monitoring-symbols-PDCCH-within-slot, and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below:

(y*(number of slots in a radio frame)+x−Monitoring-offset-PDCCH-slot)mod(Monitoring-periodicity-PDCCH-slot)=0;

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of the CORESET configuration associated with the search space configuration. A list of CORESET configurations are signaled by the gNB for each configured BWP of a serving cell, wherein each CORESET configuration is uniquely identified by a CORESET identifier. The CORESET identifier is unique amongst the BWPs of a serving cell. Note that each radio frame is of 10 ms duration. Each radio frame is identified by a radio frame number or system frame number. Each radio frame comprises several slots, wherein the number of slots in a radio frame and duration of slots depends on sub carrier spacing. The number of slots in a radio frame and duration of slots for each supported SCS is pre-defined in NR. Each CORESET configuration is associated with a list of TCI (Transmission configuration indicator) states. One DL RS ID (SSB or CSI RS) is configured per TCI state. The list of TCI states corresponding to a CORESET configuration is signaled by the gNB via RRC signaling. One of the TCI states in a TCI state list is activated and indicated to the UE by the gNB. The TCI state indicates the DL TX beam (DL TX beam is QCLed with SSB/CSI RS of TCI state) used by the gNB for transmission of a PDCCH in the PDCCH monitoring occasions of a search space.

In the next generation wireless communication system bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring a RRC connected UE with BWP(s) and telling the UE which of the configured BWPs is currently the active one. When BA is configured, the UE only monitors PDCCH on the one active BWP i.e., it does not monitor PDCCH on the entire DL frequency of the serving cell. In an RRC connected state, the UE is configured with one or more DL and UL BWPs, for each configured Serving Cell (i.e., PCell or SCell). For an activated Serving Cell, there is one active UL and DL BWP at any point in time. BWP switching for a Serving Cell is used to activate an inactive BWP and deactivate an active BWP at a particular time. BWP switching is controlled by the PDCCH indicating a downlink assignment or an uplink grant, by the bwp-InactivityTimer, by RRC signaling, or by the MAC entity itself upon initiation of a Random-Access procedure. Upon addition of an SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

In the 5^{th} generation (also referred to as NR or New Radio) wireless communication system, a UE can be in one of the following RRC states: RRC IDLE, RRC INACTIVE and RRC CONNECTED. The RRC states can further be characterized as follows:

In an RRC_IDLE state, a UE specific DRX may be configured by upper layers (i.e., NAS). The UE monitors short messages transmitted with P-RNTI over DCI. The UE monitors a paging channel for CN paging using 5G-S-TMSI. The UE performs neighboring cell measurements and cell (re-)selection. The UE acquires system information and can send SI requests (if configured).

In an RRC_INACTIVE state, a UE specific DRX may be configured by upper layers or by RRC layer. In this state, the UE stores the UE Inactive AS context. A RAN-based notification area is configured by RRC layer. The UE monitors short messages transmitted with P-RNTI over DCI. The UE monitors a paging channel for CN paging using 5G-S-TMSI and RAN paging using full I-RNTI. The UE performs neighboring cell measurements and cell (re-)selection. The UE performs RAN-based notification area updates periodically and when moving outside the configured RAN-based notification area. The UE acquires system information and can send SI requests (if configured).

In an RRC_CONNECTED state, the UE stores the AS context. Unicast data is transmitted/received to/from UE. At lower layers, the UE may be configured with a UE specific DRX. The UE monitors short messages transmitted with P-RNTI over DCI, if configured. The UE monitors control channels associated with the shared data channel to determine if data is scheduled for it. The UE provides channel quality and feedback information. The UE performs neighboring cell measurements and measurement reporting. The UE acquires system information.

Paging allows the network to reach UEs in an RRC_IDLE and RRC_INACTIVE state through Paging messages, and to notify UEs in an RRC_IDLE, RRC_INACTIVE and RRC_CONNECTED state of system information changes and ETWS (Earthquake and Tsunami Warning System)/CMAS (Commercial Mobile Alert System) indications through Short Messages. Both Paging messages and Short Messages are addressed with P-RNTI on PDCCH, but while the former is sent on a PCCH logical channel (TB carrying paging message is transmitted over PDSCH (Physical downlink shared channel)), the latter is sent over a PDCCH directly.

While in an RRC_IDLE state, the UE monitors the paging channels for CN-initiated paging. While in an RRC_INACTIVE state, the UE monitors paging channels for RAN-initiated paging and CN-initiated paging. A UE need not monitor paging channels continuously though. Paging DRX is defined where the UE in an RRC_IDLE or RRC_INACTIVE state is only required to monitor paging channels during one Paging Occasion (PO) per DRX cycle. The Paging DRX cycles are configured by the network:
1) For CN-initiated paging, a default cycle is broadcast in system information;
2) For CN-initiated paging, a UE specific cycle can be configured via NAS signaling;
3) For RAN-initiated paging, a UE-specific cycle is configured via RRC signaling;
   The UE uses the shortest of the DRX cycles applicable i.e., a UE in an RRC_IDLE state uses the shortest of the first two cycles above, while a UE in an RRC_INACTIVE state uses the shortest of the three.

A PO is a set of PDCCH monitoring occasions and can comprise multiple time slots (e.g., subframes or OFDM symbols) where paging DCI (i.e., a PDCCH addressed to a P-RNTI) can be sent. One Paging Frame (PF) is one Radio Frame and may contain one or multiple PO(s) or a starting point of a PO. A PO associated with a PF may start in the PF or after the PF.

The POs of a UE for CN-initiated and RAN-initiated paging are based on the same UE ID, resulting in overlapping POs for both. The number of different POs in a DRX cycle is configurable via system information and a network may distribute UEs to those POs based on their IDs.

In the fifth generation wireless communication system a mobile originated Small Data Transmission (SDT) procedure is also supported in the RRC_INACTIVE state. SDT is a procedure allowing data transmission while remaining in an RRC_INACTIVE state (i.e., without transitioning to an RRC_CONNECTED state). SDT is enabled on a radio bearer basis and is initiated by the UE only if less than a configured amount of UL data awaits transmission across all radio bearers for which SDT is enabled, the DL RSRP is above a configured threshold, and a valid SDT resource is available.

An SDT procedure is initiated with either a transmission over a RACH (configured via system information) or over Type 1 CG resources (configured via dedicated signaling in RRCRelease). The SDT resources can be configured on the initial BWP for both RACH and CG. RACH and CG resources for SDT can be configured on either or both of NUL and SUL carriers. For RACH, the network configures 2-step and/or 4-step RA resources for SDT. When both 2-step and 4-step RA resources for SDT are configured, the UE selects the RA type based on DL RSRP. CFRA is not supported for SDT over RACH.

Once initiated, the SDT procedure is terminated successfully after the UE is directed to an RRC_IDLE or RRC_INACTIVE state (via RRCRelease) or to an RRC_CONNECTED state (via RRCResume), or unsuccessfully upon cell re-selection, expiry of the SDT failure detection timer, or an RLC entity reaching a configured maximum retransmission threshold. Upon failure of the SDT procedure, the UE transitions to an RRC_IDLE state.

After the initial PUSCH transmission during the SDT procedure, subsequent transmissions are handled differently depending on the type of resource used to initiate the SDT procedure:
When using CG resources, the network can schedule subsequent UL transmissions using dynamic grants or they can take place on the following CG resource occasions. The DL transmissions are scheduled using dynamic assignments. The UE can initiate subsequent UL transmission only after reception of confirmation for the initial PUSCH transmission from the network.
When using RACH resources, the network can schedule subsequent UL and DL transmissions using dynamic UL grants and DL assignments, respectively, after the completion of the RA procedure.

An SDT procedure over CG resources can only be initiated with valid UL timing alignment. The UL timing alignment is maintained by the UE based on a network configured timing alignment timer and DL RSRP of the configured number of highest ranked SSBs. Upon expiry of the timing alignment timer, the CG resources are released. Logical channel restrictions can be configured by the network for radio bearers enabled for SDT and are applied by the UE regardless of whether the SDT procedure is initiated with either a transmission over RACH or over Type 1 CG resources.

While in an RRC_CONNECTED state and while in an RRC_INACTIVE state with an ongoing SDT procedure, the UE monitors the paging channels in any PO signaled in system information for an SI change indication and PWS notification. In case of BA, a UE in an RRC_CONNECTED state only monitors paging channels on the active BWP with common search space configured.

For operation with shared spectrum channel access, a UE can be configured for an additional number of PDCCH monitoring occasions in its PO to monitor for paging. However, when the UE detects a PDCCH transmission within the UE's PO addressed with P-RNTI, the UE is not required to monitor the subsequent PDCCH monitoring occasions within this PO.

The NR system enables resource efficient delivery of multicast/broadcast services (MBS). A UE can receive data of an MBS multicast session in an RRC_CONNECTED state or RRC_INACTIVE state. To receive the multicast service, the UE performs a join procedure to the MBS multicast session. It is up to gNB to decide whether the UE receives the data of the MBS multicast session in an RRC CONNECTED state or an RRC_INACTIVE state. The gNB moves the UE from an RRC_CONNECTED state to an RRC_INACTIVE state via a RRCRelease message, and moves the UE from an RRC_INACTIVE state to an RRC_CONNECTED state via the group notification or UE-specific paging.

If the UE which joined a multicast session is in an RRC_CONNECTED state and when the multicast session is activated, the gNB may send a RRCReconfiguration message with a relevant MBS configuration for the multicast session to the UE.

If the gNB configures the UE to receive the MBS multicast session in an RRC_INACTIVE state, the gNB provides the PTM configuration via a RRCRelease message for the MBS multicast session. The gNB may indicate which multicast service(s) can be received in an RRC_INACTIVE state in a RRCRelease message. Upon receiving the indication(s), the UE is not to suspend the corresponding multicast MRBs and to keep using them in an RRC_INACTIVE state. When the PTM configuration is changed, the multicast MCCH of the serving cell is used to provide the PTM configuration. The UE in an RRC_CONNECTED state is not required to read multicast MCCH.

A notification mechanism is used to announce the change of the multicast MCCH contents due to multicast session PTM configuration modification or session deactivation. The scheduling information for multicast MCCH reception is provided via a SIBx and optionally via dedicated signaling.

When there is temporarily no data to be sent to the UEs for a multicast session that is active, the gNB may move the UE to an RRC_INACTIVE state. When an MBS multicast session is deactivated, the gNB may move the UE in an RRC_CONNECTED state to an RRC_IDLE or RRC_INACTIVE state. For UEs receiving data of MBS multicast session in an RRC_INACTIVE state, the gNB notifies the MBS multicast session deactivation via multicast MCCH. In this case, the UE can stay in an RRC_INACTIVE state and can stop monitoring the corresponding G-RNTI. gNBs supporting MBS use a group notification mechanism to notify the UEs in an RRC_IDLE or RRC_INACTIVE state when a multicast session has been activated by the CN. gNBs supporting MBS use a group notification mechanism to notify the UEs in an RRC_INACTIVE state when the session is already activated and the gNB has multicast session data to deliver. Upon reception of the group notification, the UEs reconnect to the network or resume the connection and transition to an RRC_CONNECTED state from either an RRC_IDLE state or an RRC_INACTIVE state. Upon reception of the group notification with TMGI-specific indication(s) to stay in an RRC_INACTIVE state to receive the multicast session, the UE stays in an RRC_INACTIVE state and starts monitoring the corresponding G-RNTI, if a PTM configuration is available. The UE is required to resume an RRC connection to get the PTM configuration if the PTM configuration is unavailable upon session activation or data transmission resumption. The group notification is addressed with a P-RNTI on the PDCCH. A paging message for group notification contains MBS session ID which is utilized to page all UEs in RRC_IDLE and RRC_INACTIVE states that joined the associated MBS multicast session, i.e., UEs are not paged individually. The UE stops monitoring for group notifications related to a specific multicast session, i.e., stops checking for the MBS session ID in the paging message, when the UE enters an RRC_CONNECTED state. The UE does not monitor for group notifications for these cases, i.e., once this UE leaves this multicast session or the network requests the UE to leave, or the network releases the multicast session. The UE in an RRC_INACTIVE state may be transferred to an RRC_CONNECTED state by the UE-specific paging. If the UE is notified by both group notification and the UE-specific paging, the UE follows the UE-specific paging and goes to an RRC_CONNECTED state.

If the UE in an RRC_IDLE state that joined an MBS multicast session is camping on a gNB not supporting MBS, the UE may be notified about multicast session activation or data availability by CN-initiated paging where the CN pages each UE individually. If the UE in an RRC_INACTIVE state that joined the MBS multicast session is camping on a gNB not supporting MBS, the UE may be notified about data availability individually by RAN-initiated paging.

In multi-beam operations, the UE assumes that the same paging message and the same Short Message are repeated in all transmitted beams and thus the selection of the beam(s) for the reception of the paging message and Short Message is up to UE implementation. The paging message is the same for both RAN initiated paging and CN initiated paging. The UE initiates an RRC Connection Resume procedure upon receiving RAN initiated paging. If the UE receives a CN initiated paging in an RRC_INACTIVE state, the UE moves to an RRC_IDLE state and informs the NAS.

The PF and PO for paging are determined (by the UE and the base station, e.g., gNB) by the following formulae:

SFN for the PF is determined by:

(SFN+PF_offset)mod T=(T div N)*(UE_ID mod N).

Index (i_s), indicating the index of the PO is determined by:

i_s=floor(UE_ID/N)mod Ns.

The following parameters are used for the calculation of PF and i_s above:
T: DRX cycle of the UE.
N: number of total paging frames in T; N is one of T, T/2, T/4, T/8, T/16.
Ns: number of paging occasions for a PF; NS is one of 1, 2, 4.
PF_offset: offset used for PF determination
UE_ID: if the UE operates in eDRX: 5G-S-TMSI mod 4096, otherwise 5G-S-TMSI mod 1024.

To facilitate a gNB reduced downlink transmission/uplink reception activity, an RRC_CONNECTED UE can be configured with a periodic cell DTX/DRX pattern (i.e., active and non-active periods). Pattern configuration for cell DRX/DTX is common for the UEs supporting this feature in the cell. The cell DTX and cell DRX can be configured independently. When the cell DTX is configured in an RRC_CONNECTED state, the UE in the RRC_CONNECTED state does not have to continuously monitor UE specific PDCCH or SPS occasions during cell non-active periods. When the cell DRX is configured in an RRC_CONNECTED state, the UE in the RRC_CONNECTED state does not transmit on CG resources or transmit a SR during cell non-active periods. This feature is only applied to UEs in an RRC_CONNECTED state and it does not impact RACH, paging, and system information broadcasting. Once the gNB recognizes there is an emergency call or public safety related service (e.g., MPS or MCS), the network should ensure that there is no negative QoS impact to that service (e.g., it may release cell DTX/DRX configuration). In order to activate/deactivate Cell DTX/DRX configuration, the network can send group common PDCCH.

A periodic cell DTX pattern in an RRC_CONNECTED state may be configured by a ‘duration’ and ‘period’ field wherein during the ‘duration’ interval which occurs periodically every ‘period’, the cell does not perform transmission (or stops certain transmissions as explained earlier). Alternately, the periodic cell DTX pattern may be configured by a ‘duration’ and ‘period’ field wherein during the ‘duration’ interval which occurs periodically every ‘period’, the cell performs transmission and during the interval ‘period-duration’ the cell does not perform transmission (or stops certain transmissions) as explained earlier. The period/time where cell does not perform transmission (or stops certain transmissions) is called inactive period/time.

A Periodic cell DRX pattern in an RRC_CONNECTED state may be configured by a ‘duration’ and ‘period’ field wherein during the ‘duration’ interval which occurs periodically every ‘period’, the cell does not perform reception (or stops certain receptions as explained earlier). Alternately, the periodic cell DRX pattern may be configured by a ‘duration’ and ‘period’ field wherein during the ‘duration’ interval which occurs periodically every ‘period’, the cell performs reception and during the interval ‘period-duration’ the cell does not perform reception (or stops certain receptions as explained earlier). During the cell level DRX duration where the network (i.e., base station) does not receive transmission (or certain transmissions) from the UE on the uplink of that cell, the UE does not transmit (or does not transmit) certain transmissions in uplink of that cell. The period/time where the cell does not perform reception (or stops certain receptions) is called an inactive period/time.

In the some designs, Cell DTX/DRX is applied to UEs in an RRC_CONNECTED state and the DTX/DRX does not impact RACH, paging, and system information broadcasting. The network (i.e., gNB or base station) needs to periodically transmit broadcast signals such as SSBs, system information such as SIB1 and emergency SIBs for RRC_IDLE and RRC_INACTIVE UEs in the cell. This leads to increased network energy consumption. The Cell DTX cycle can be configured for RRC_IDLE and RRC_INACTIVE UEs to enhance network energy savings. The present disclosure provides solutions to address several issues such as configuration of the Cell DTX cycle, minimizing impact of the Cell DTX cycle to paging, minimizing delay in delivering SI update and/or emergency notifications when the Cell DTX cycle is configured, and monitoring PF/PO considering the DRX cycle for paging and the Cell DTX cycle.

In the some designs, MIB/SSBs and SIB1 are periodically transmitted/broadcasted. MIB/SSBs and SIB1 together may also be referred to as minimum system information. SIB1 may also be referred to as remaining minimum system information. SIB1 periodicity is 160 ms with repetition at every 20 ms within 160 ms interval. MIB/SSBs periodicity can vary from 5 ms to 160 ms. Periodic transmissions lead to increased network energy consumption. On demand MIB/SSBs and SIB1 can reduce network energy consumption. In order to support on demand MIB/SSBs and/or SIB1, methods to indicate to a UE that MIB/SSBs and/or SIB1 is provided on demand, methods to request MIB/SSBs and/or SIB1, and methods to configure resources to request MIB/SSBs and/or SIB1 are provided in the present disclosure.

In the some designs, a UE in an RRC_INACTIVE state monitors PDCCH addressed to P-RNTI in its PO for receiving a paging message containing a group notification. If the UE is in an RRC_INACTIVE and the UE has joined one or more MBS session(s) indicated by the TMGI(s) included in the pagingGroupList in the received paging message and if the UE is configured with multicast reception in an RRC_INACTIVE and if inactive ReceptionAllowed is not included in the received paging message for at least one of the MBS session(s) that the UE has joined, the UE initiates the RRC connection resumption procedure and enters an RRC_CONNECTED state. One consequence of this operation is that a small data transmission procedure in an RRC_INACTIVE state will be interrupted if a paging message containing the group notification is received while the SDT procedure is ongoing in an RRC_INACTIVE state. Resumption of an RRC connection resumption procedure while a SDT procedure is ongoing in an RRC_INACTIVE state will lead to reuse of the same security keys which were previously used for sending the RRC resume message at the initiation of the SDT procedure leading to security threats. One option to resolve this issue would be not monitoring paging for a group notification while an SDT procedure is ongoing. The drawback of this is that the UE will miss the notification of activation of one or more MBS sessions and as a result the UE will not be able to receive the data of those activated MBS sessions. The present disclosure provides methods to overcome these issues.

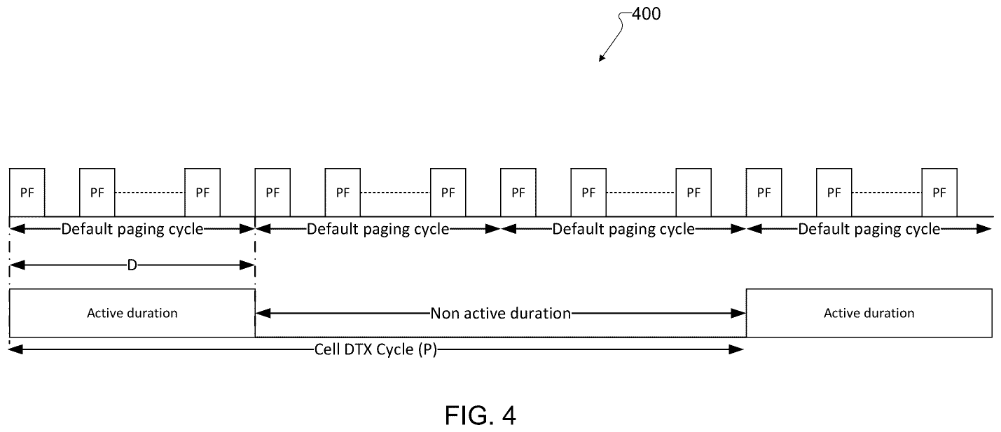

FIG. 4 illustrates an example 400 of a Cell DTX cycle configuration in a cell according to embodiments of the present disclosure. The embodiment of Cell DTX cycle configuration in a cell of FIG. 4 is for illustration only. Different embodiments of a Cell DTX cycle configuration in a cell could be used without departing from the scope of this disclosure.

In the example of FIG. 4, the Cell DTX cycle configuration comprises an active duration (D) which occurs periodically with a periodicity P.

In one embodiment, the active duration (D) is equal to the length of one default DRX cycle/default paging cycle/DRX cycle/idle mode DRX cycle as shown in FIG. 4. In another embodiment, the active duration (D) is in multiples of the length of one default DRX cycle/default paging cycle/DRX cycle/idle mode DRX cycle.

In one embodiment, the active duration (D) can be signaled by a network element (e.g., a gNB or base station). In another embodiment, the length (L) of the default DRX cycle/default paging cycle/DRX cycle/idle mode DRX cycle and a multiplication factor (M) to indicate the length of active duration (D) is signaled by the network and the active duration (D) is equal to M*L. For signaling, these parameter(s) can be included in system information (e.g., a SIB) or in an RRC message (e.g., RRCRelease message or RRCReconfiguration message or SI message or any other message).

In one embodiment, the length/period of the Cell DTX cycle (P) is in multiples of length of the default DRX cycle/default paging cycle/DRX cycle/idle mode DRX cycle. In the example of FIG. 4, the length/period of the Cell DTX cycle (P) is three times the length of the default DRX cycle/default paging cycle/DRX cycle/idle mode DRX cycle.

In one embodiment, the length/period of the Cell DTX cycle (P) can be signaled by a network element (e.g., a gNB or base station). In another embodiment, the length (L) of the default DRX cycle/default paging cycle/DRX cycle/idle mode DRX cycle and a multiplication factor (J) to indicate the length/period of the Cell DTX cycle (P) is signaled by the network and the value of P is equal to J*L. For signaling, these parameter(s) can be included in system information (e.g., a SIB) or in an RRC message (e.g., an RRCRelease message or an RRCReconfiguration message or an SI message or any other message).

In one embodiment, the start of the Cell DTX cycle boundary is aligned with the start of default the DRX cycle/default paging cycle/DRX cycle/idle mode DRX cycle as shown in FIG. 4.

Note that the default DRX cycle/default paging cycle/DRX cycle/idle mode DRX cycle comprises one or more paging frames (PFs) and/or paging occasions (POs). The number of paging frames may be signaled using the parameter N and the number of paging occasions per PF may be signaled using the parameter Ns.

In one embodiment, the active duration (D) is equal to length of one SSB periodicity (K). In another embodiment, the active duration (D) is in multiples of the SSB periodicity.

In one embodiment, the active duration (D) can be signaled by a network element (e.g., a gNB or base station). In another embodiment, the SSB periodicity (K) and a multiplication factor (M) to indicate length of active duration (D) is signaled by the network and the active duration (D) is equal to M*K. For signaling, these parameter(s) can be included in system information (e.g., a SIB) or in an RRC message (e.g., an RRCRelease message or an RRCReconfiguration message or an SI message or any other message).

In one embodiment, the length/period of the Cell DTX cycle (P) is in multiples of the SSB periodicity (L).

In one embodiment, the length/period of the Cell DTX cycle (P) can be signaled by a network element (e.g., a gNB or base station). In another embodiment, the SSB periodicity (K) and a multiplication factor (J) to indicate the length/period of the Cell DTX cycle (P) is signaled by the network and the value of P is equal to J*K. For signaling, these parameter(s) can be included in system information (e.g., a SIB) or in an RRC message (e.g., an RRCRelease message or an RRCReconfiguration message or an SI message or any other message).

In one embodiment, the start of the Cell DTX cycle boundary is aligned with the start of SSB the period.

Although FIG. 4 illustrates an example 400 of a Cell DTX cycle configuration in a cell, various changes may be made to FIG. 4. For example, various changes to the Cell DTX cycle, the default paging cycle, etc. could be made according to particular needs.

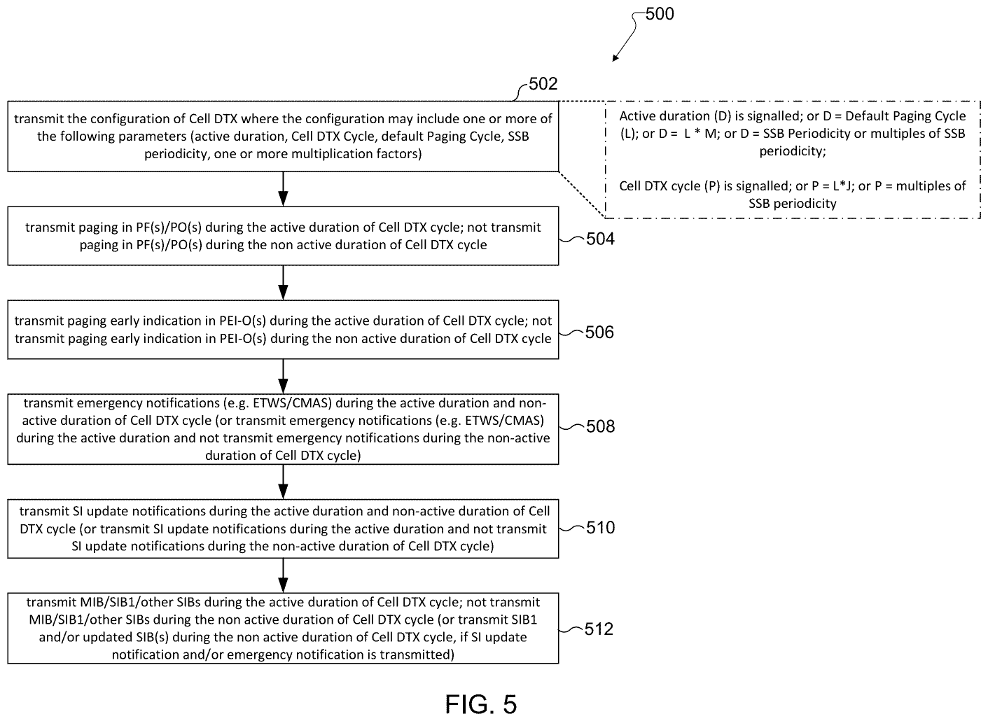

FIG. 5 illustrates an example network operation during a Cell DTX cycle 500 according to embodiments of the present disclosure. An embodiment of the operation illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments for a network operation during a Cell DTX cycle could be used without departing from the scope of this disclosure.

In the example of FIG. 5, the network operation begins at step 502. At step 502, a network element such as BS 102 of FIG. 1 transmits the configuration of Cell DTX. The configuration may include one or more of the following parameters: active duration (D), Cell DTX Cycle (P), default Paging Cycle (L), SSB periodicity (K), and one or more multiplication factors (M, J, etc.). The configuration can be included in system information (e.g., a SIB) or in an RRC message (e.g., an RRCRelease message or an RRCReconfiguration message or an SI message or any other message). Active duration and non-active duration of the Cell DTX cycle are determined based on the configuration.

At step 504, in one embodiment, the network element (e.g., a gNB or base station) transmits paging (e.g., a PDCCH addressed to a P-RNTI) in PF(s) during the active duration of the Cell DTX cycle. The network element (e.g., a gNB or base station) may not transmit paging (e.g., a PDCCH addressed to a P-RNTI) in PF(s) during the non-active duration of the Cell DTX cycle. For example, if there is paging for a UE and the UE's next available PF is in the non-active duration of the Cell DTX cycle, the network element does not transmit the paging for UE in this PF. The network element transmits the paging later in the UE's PF in the active duration of the Cell DTX cycle. For example, if there is paging for a UE and the UE's next available PF is in the active duration of the Cell DTX cycle, the network element transmits paging for the UE in this PF.

In one embodiment, whether the network element (e.g., a gNB or base station) may transmit paging (e.g., a PDCCH addressed to a P-RNTI) in PF(s) during the non-active duration of the Cell DTX cycle can be indicated/signaled in system information (e.g., a SIB) or in an RRC message (e.g., an RRCRelease message or an RRCReconfiguration message or an SI message or any other message).

In one embodiment, the network element (e.g., a gNB or base station) transmits paging (e.g., a PDCCH addressed to a P-RNTI) in the PO(s) during the active duration of the Cell DTX cycle. The network element (e.g., a gNB or base station) may not transmit paging (e.g., a PDCCH addressed to a P-RNTI) in the PO(s) during the non-active duration of the Cell DTX cycle. For example, if there is paging for a UE and the UE's next available PO is in the non-active duration of the Cell DTX cycle, the network element does not transmit paging for UE in this PO. The network element transmits paging later in the UE's PO in the active duration of the Cell DTX cycle. For example, if there is paging for a UE and the UE's next available PO is in the active duration of the Cell DTX cycle, network transmits paging for UE in this PO.

In one embodiment, whether a network element (e.g., a gNB or base station) may transmit paging (e.g., a PDCCH addressed to a P-RNTI) in PO(s) during the non-active duration of the Cell DTX cycle can be indicated/signaled in system information (e.g., a SIB) or in an RRC message (e.g., an RRCRelease message or an RRCReconfiguration message or an SI message or any other message).

At step 506, in one embodiment, the network element (e.g., a gNB or base station) transmits a paging early indication (e.g., a PDCCH addressed to a P-RNTI) in paging early indication-occasion(s) (PEI-O [s]) during the active duration of the Cell DTX cycle. The network element (e.g., a gNB or base station) may not transmit the paging early indication (e.g., a PDCCH addressed to a P-RNTI) in the PEI-O(s) during the non-active duration of the Cell DTX cycle.

In one embodiment, whether the network element (e.g., a gNB or base station) may transmit the paging early indication (e.g., a PDCCH addressed to a P-RNTI) in PEI-O(s) during the non-active duration of the Cell DTX cycle can be indicated/signaled in system information (e.g., a SIB) or in an RRC message (e.g., an RRCRelease message or an RRCReconfiguration message or an SI message or any other message).

At step 508, in one embodiment, the network element (e.g., a gNB or base station) may transmit emergency notifications (e.g., an ETWS/CMAS) during the active duration of the Cell DTX cycle and the network element (e.g., a gNB or base station) may not transmit emergency notifications (e.g., an ETWS/CMAS) during the non-active duration of the Cell DTX cycle. In one embodiment, the network element (e.g., a gNB or base station) may transmit emergency notifications (e.g., an ETWS/CMAS) during the active duration of the Cell DTX cycle and the network element (e.g., a gNB or base station) may transmit emergency notifications (e.g., an ETWS/CMAS) during the non-active duration of the Cell DTX cycle.

At step 510, in one embodiment, the network element (e.g., a gNB or base station) may transmit an SI update/change notification during the active duration of the Cell DTX cycle and the network element (e.g., a gNB or base station) may not transmit the SI update notification during the non-active duration of the Cell DTX cycle. In one embodiment, the network element (e.g., a gNB or base station) may transmit the SI update notification during the active duration of the Cell DTX cycle and the network element (e.g., a gNB or base station) may transmit the SI update notification during the non-active duration of the Cell DTX cycle.

In one embodiment, the network element (e.g., a gNB or base station) may transmit the SI update/change notification or emergency notifications (e.g., an ETWS/CMAS) and/or short messages during the non-active duration of the Cell DTX cycle but may not transmit a PDCCH addressed to a P-RNTI scheduling the paging message.

In one embodiment, the network element (e.g., a gNB or base station) may transmit a PDCCH addressed to a P-RNTI for the SI update notification and/or emergency notifications (e.g., an ETWS/CMAS) or short messages during the non-active duration of the Cell DTX cycle but does not transmit the PDCCH addressed to the P-RNTI scheduling the paging message during the non-active duration of the Cell DTX cycle.

In one embodiment, whether the network element (e.g., a gNB or base station) may transmit the PDCCH addressed to the P-RNTI for the SI update notification or emergency notifications (e.g., an ETWS/CMAS) or short messages during the non-active duration of the Cell DTX cycle can be indicated/signaled in system information (e.g., a SIB) or in an RRC message (e.g., an RRCRelease message or an RRCReconfiguration message or an SI message or any other message).

In one embodiment, the network element (e.g., a gNB or base station) may transmit emergency notifications (e.g., an ETWS/CMAS) during the non-active duration of the Cell DTX cycle but may not transmit a PDCCH addressed to a P-RNTI scheduling the paging message and/or a PDCCH addressed to the P-RNTI for an SI update notification.

In one embodiment, the network element (e.g., a gNB or base station) may transmit the PDCCH addressed to the P-RNTI for emergency notifications (e.g., an ETWS/CMAS) during the non-active duration of the Cell DTX cycle but may not transmit the PDCCH addressed to the P-RNTI scheduling the paging message and/or the PDCCH addressed to the P-RNTI for the SI update notification during the non-active duration of the Cell DTX cycle.

In one embodiment, whether the network element (e.g., a gNB or base station) may transmit the PDCCH addressed to the P-RNTI for the emergency notifications (e.g., an ETWS/CMAS) during the non-active duration of the Cell DTX cycle can be indicated/signaled in system information (e.g., a SIB) or in an RRC message (e.g., an RRCRelease message or an RRCReconfiguration message or an SI message or any other message).

At step 512, in one embodiment, the network element (e.g., a gNB or base station) transmits a MIB/SIB1/other SIBs during the active duration of the Cell DTX cycle. The network element (e.g., a gNB or base station) may not transmit the MIB/SIB1/other SIBs during the non-active duration of the Cell DTX cycle. In one embodiment, the network element (e.g., a gNB or base station) may transmit a SIB1 and/or updated SIB(s) during the non-active duration of the Cell DTX cycle, if an SI update notification or emergency notification (e.g., an ETWS/CMAS) is transmitted (during the non-active duration of the Cell DTX cycle and/or during the non-active duration of the Cell DTX cycle).

In one embodiment, the network element (e.g., a gNB or base station) transmits a multicast common control channel (MCCH) and a multicast traffic channel (MTCH) during the active duration of the Cell DTX cycle. The network element (e.g., a gNB or base station) may not transmit the multicast common control channel (MCCH) and the multicast traffic channel (MTCH) during the non-active duration of the Cell DTX cycle.

In one embodiment, whether the network element (e.g., a gNB or base station) may transmit the MCCH/MTCH during the non-active duration of the Cell DTX cycle can be indicated/signaled in system information (e.g., a SIB) or in an RRC message (e.g., an RRCRelease message or an RRCReconfiguration message or an SI message or any other message).

Although FIG. 5 illustrates one example of a network operation during a Cell DTX cycle 500, various changes may be made to FIG. 5. For example, while shown as a series of steps, various steps in FIG. 5 could overlap, occur in parallel, occur in a different order, occur any number of times, be omitted, or replaced by other steps.

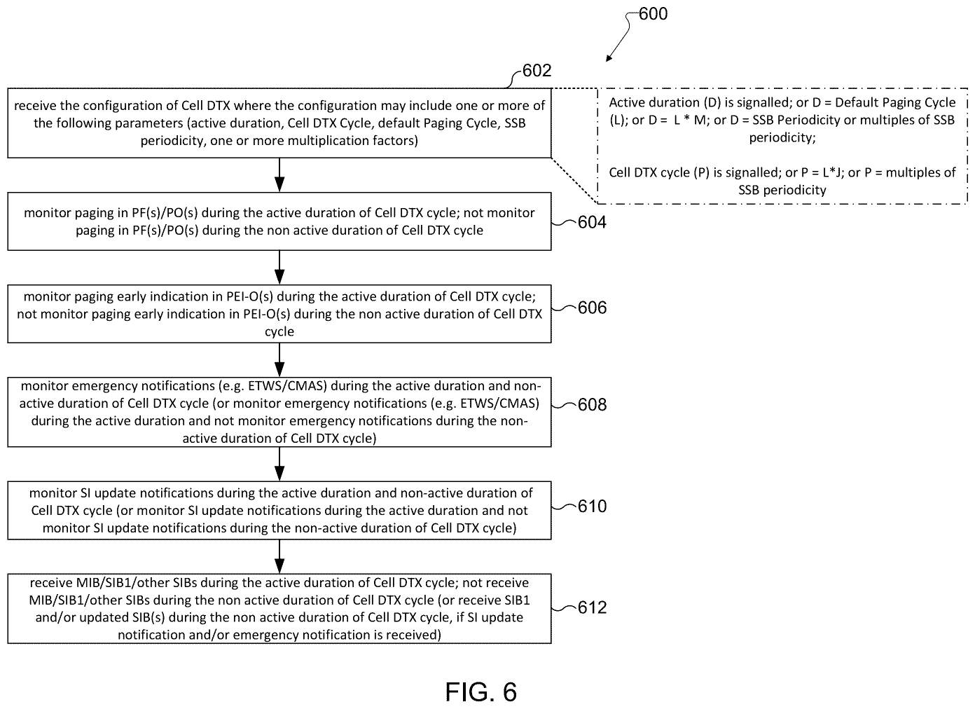

FIG. 6 illustrates an example UE operation during a Cell DTX cycle 600 according to embodiments of the present disclosure. An embodiment of the operation illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments for a UE operation during a Cell DTX cycle could be used without departing from the scope of this disclosure.

In the example of FIG. 6, the UE operation begins at step 602. At step 602, a UE such as UE 116 of FIG. 1 receives the configuration of a Cell DTX. The configuration may include one or more of the following parameters: active duration (D), Cell DTX Cycle (P), default Paging Cycle (L), SSB periodicity (K), and one or more multiplication factors (M, J, etc.). Active duration and non-active duration are determined based on this configuration. The configuration can be received in system information (e.g., a SIB) or in an RRC message (e.g., an RRCRelease message or an RRCReconfiguration message or an SI message or any other message). Active duration and non-active duration of the Cell DTX cycle are determined based on this configuration.

At step 604, In one embodiment, the UE monitors for paging (e.g., a PDCCH addressed to a P-RNTI) in its PF(s) during the active duration of the Cell DTX cycle. The UE may not monitor for paging (e.g., a PDCCH addressed to a P-RNTI) in its PF(s) during the non-active duration of the Cell DTX cycle.

In one embodiment, whether a network element (e.g., a gNB or base station) may transmit or the UE should monitor for paging (e.g., a PDCCH addressed to a P-RNTI) in its PF(s) during the non-active duration of the Cell DTX cycle can be indicated/signaled in system information (e.g., a SIB) or in an RRC message (e.g., an RRCRelease message or an RRCReconfiguration message or an SI message or any other message). Based on this indication, the UE may monitor for paging (e.g., a PDCCH addressed to a P-RNTI) in its PF(s) during the non-active duration of the Cell DTX cycle.

In one embodiment, the UE monitors for paging (e.g., a PDCCH addressed to a P-RNTI) in the PO(s) during the active duration of the Cell DTX cycle. The UE may not monitor for paging (e.g., a PDCCH addressed to a P-RNTI) in the PO(s) during the non-active duration of the Cell DTX cycle.

In one embodiment, whether a network element (e.g., a gNB or base station) may transmit or the UE should monitor for paging (e.g., a PDCCH addressed to a P-RNTI) in its PO(s) during the non-active duration of the Cell DTX cycle can be indicated/signaled in system information (e.g., a SIB) or in an RRC message (e.g., an RRCRelease message or an RRCReconfiguration message or an SI message or any other message). Based on this indication, the UE may monitor for paging (e.g., a PDCCH addressed to a P-RNTI) in its PO(s) during the non-active duration of the Cell DTX cycle.

At step 606, in one embodiment, the UE monitors for a paging early indication (e.g., a PDCCH addressed to a P-RNTI) in its PEI-O(s) during the active duration of the Cell DTX cycle. The UE may not monitor for a paging early indication (e.g., a PDCCH addressed to a P-RNTI) in its PEI-O(s) during the non-active duration of the Cell DTX cycle.

In one embodiment, whether a network element (e.g., a gNB or base station) may transmit or the UE should monitor for a paging early indication (e.g., a PDCCH addressed to a P-RNTI) in its PEI-O(s) during the non-active duration of the Cell DTX cycle can be indicated/signaled in system information (e.g., a SIB) or in an RRC message (e.g., an RRCRelease message or an RRCReconfiguration message or an SI message or any other message). Based on this indication, the UE may monitor for a paging early indication (e.g., a PDCCH addressed to a P-RNTI) in its PEI-O(s) during the non-active duration of the Cell DTX cycle.

At step 608, in one embodiment, the UE may monitor for emergency notifications (e.g., an ETWS/CMAS) during the active duration of the Cell DTX cycle and the UE may not monitor emergency notifications (e.g., an ETWS/CMAS) during the non-active duration of the Cell DTX cycle. In one embodiment, the UE may monitor for emergency notifications (e.g., an ETWS/CMAS) during the active duration of the Cell DTX cycle and the UE may monitor emergency notifications (e.g., an ETWS/CMAS) during the non-active duration of the Cell DTX cycle.

In one embodiment, whether the network element (e.g., a gNB or base station) may transmit or the UE should monitor a PDCCH addressed to a P-RNTI for emergency notifications (e.g., an ETWS/CMAS) during the non-active duration of the Cell DTX cycle can be indicated/signaled in system information (e.g., a SIB) or in an RRC message (e.g., an RRCRelease message or an RRCReconfiguration message or an SI message or any other message). Based on this indication, the UE may monitor for the PDCCH addressed to the P-RNTI for emergency notifications (e.g., an ETWS/CMAS) during the non-active duration of the Cell DTX cycle.

At step 610, in one embodiment, the UE may monitor for SI update notifications during the active duration of the Cell DTX cycle and UE may not monitor for SI update notifications during the non-active duration of the Cell DTX cycle. In one embodiment, the UE may monitor for SI update notifications during the active duration of the Cell DTX cycle and UE may monitor for SI update notifications during the non-active duration of the Cell DTX cycle.

In one embodiment, whether the network element (e.g., a gNB or base station) may transmit or the UE should monitor for a PDCCH addressed to a P-RNTI for an SI update notification during the non-active duration of the Cell DTX cycle can be indicated/signaled in system information (e.g., a SIB) or in an RRC message (e.g., an RRCRelease message or an RRCReconfiguration message or an SI message or any other message). Based on this indication, the UE may monitor for the PDCCH addressed to the P-RNTI for an SI update notification during the non-active duration of the Cell DTX cycle.

In one embodiment, the UE may monitor for SI update notifications or emergency notifications (e.g., an ETWS/CMAS) and/or short messages during the active duration of the Cell DTX cycle. In one embodiment, the UE may monitor for SI update notifications or emergency notifications (e.g., an ETWS/CMAS) and/or short messages during the non-active duration of the Cell DTX cycle but may not monitor for a PDCCH addressed to a P-RNTI scheduling a paging message.

In one embodiment, the UE may monitor a PDCCH addressed to a P-RNTI for SI update notifications and/or emergency notifications (e.g., an ETWS/CMAS) or short messages during the non-active duration of the Cell DTX cycle but may not monitor the PDCCH addressed to the P-RNTI scheduling a paging message during the non-active duration of the Cell DTX cycle.

In one embodiment, whether the network element (e.g., a gNB or base station) may transmit or the UE should monitor a PDCCH addressed to a P-RNTI for SI update notifications or emergency notifications (e.g., an ETWS/CMAS) or short messages during the non-active duration of the Cell DTX cycle can be indicated/signaled in system information (e.g., a SIB) or in an RRC message (e.g., an RRCRelease message or an RRCReconfiguration message or an SI message or any other message). Based on this indication, the UE may monitor the PDCCH addressed to the P-RNTI for SI update notifications and/or emergency notifications (e.g., an ETWS/CMAS) or short messages during the non-active duration of the Cell DTX cycle.

In one embodiment, the UE may monitor emergency notifications (e.g., an ETWS/CMAS) during the non-active duration of the Cell DTX cycle but may not monitor a PDCCH addressed to a P-RNTI scheduling a paging message and/or the PDCCH addressed to the P-RNTI for SI update notifications.

In one embodiment, the UE may monitor a PDCCH addressed to a P-RNTI for emergency notifications (e.g., an ETWS/CMAS) during the non-active duration of the Cell DTX cycle but may not monitor the PDCCH addressed to the P-RNTI scheduling a paging message and/or the PDCCH addressed to the P-RNTI for SI update notifications during the non-active duration of the Cell DTX cycle.

In one embodiment, whether the network element (e.g., a gNB or base station) may transmit or the UE should monitor a PDCCH addressed to a P-RNTI for emergency notifications (e.g., an ETWS/CMAS) during the non-active duration of the Cell DTX cycle can be indicated/signaled in system information (e.g., a SIB) or in an RRC message (e.g., an RRCRelease message or an RRCReconfiguration message or an SI message or any other message). Based on this indication, the UE may monitor the PDCCH addressed to the P-RNTI for emergency notifications (e.g., an ETWS/CMAS) during the non-active duration of the Cell DTX cycle.

At step 612, in one embodiment, the UE may receive a MIB/SIB1/other SIBs during the active duration of the Cell DTX cycle. The UE may not receive the MIB/SIB1/other SIBs during the non-active duration of the Cell DTX cycle. In one embodiment, the UE may receive a SIB1 and/or updated SIB(s) during the non-active duration of the Cell DTX cycle, if an SI update notification or emergency notification (e.g., an ETWS/CMAS) is received (during the non-active duration of the Cell DTX cycle and/or during the non-active duration of the Cell DTX cycle).

Although FIG. 6 illustrates one example of a UE operation during the Cell DTX cycle 600, various changes may be made to FIG. 6. For example, while shown as a series of steps, various steps in FIG. 6 could overlap, occur in parallel, occur in a different order, occur any number of times, be omitted, or replaced by other steps.

In one embodiment, the UE may receive a multicast common control channel (MCCH) and multicast traffic channel (MTCH) during the active duration of the Cell DTX cycle. The UE may not receive the multicast common control channel (MCCH) and multicast traffic channel (MTCH) during the non-active duration of the Cell DTX cycle.

In one embodiment, whether the network element (e.g., a gNB or base station) may transmit or the UE can receive a MCCH/MTCH during the non-active duration of the Cell DTX cycle can be indicated/signaled in system information (e.g., a SIB) or in an RRC message (e.g., an RRCRelease message or an RRCReconfiguration message or an SI message or any other message). Based on this indication, the UE may receive the MCCH/MTCH during the non-active duration of the Cell DTX cycle.

In one embodiment, if a Cell DTX cycle is enabled in a camped cell and the UE is interested in MBS service, the UE may trigger cell reselection and camp on a cell where a Cell DTX cycle is not enabled, and which supports MBS.

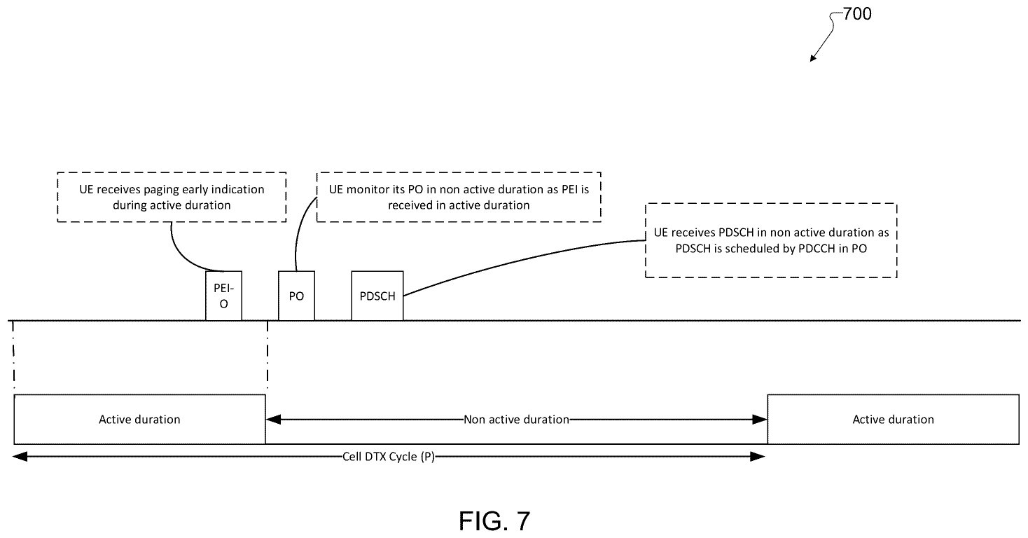

In one embodiment, if the UE's PEI-O is in an active duration of the Cell DTX cycle and UE receives a paging early indication (or paging early indication for its subgroup), the UE monitors its PO even if the PO is in the non-active duration of the Cell DTX cycle as illustrated in FIG. 7.

FIG. 7 illustrates an example 700 of PO monitoring according to embodiments of the present disclosure. The embodiment of PO monitoring of FIG. 7 is for illustration only. Different embodiments of PO monitoring could be used without departing from the scope of this disclosure.

In the example of FIG. 7, the UE's PEI-O is in an active duration of the Cell DTX cycle. If the UE receives a paging early indication (or a paging early indication for its subgroup), the UE monitors its PO even if the PO is in the non-active duration of the Cell DTX cycle. If a PDCCH addressed to a P-RNTI scheduling a PDSCH paging message is received in the monitored PO, the UE receives the scheduled PDSCH even if the scheduled PDSCH is in the non-active duration of Cell DTX cycle.

If the UE's PEI-O is in an active duration of the Cell DTX cycle and the network transmits a paging early indication (or paging early indication for UE's subgroup), the network transmits a PDCCH addressed to a P-RNTI in the UE's PO even if the PO is in a non-active duration of the Cell DTX cycle. If the PDCCH addressed to the P-RNTI scheduling PDSCH paging message is transmitted in this PO, the network transmits the scheduled PDSCH for the paging message even if the scheduled PDSCH is in a non-active duration of the Cell DTX cycle.

Although FIG. 7 illustrates an example 700 of PO monitoring, various changes may be made to FIG. 7. For example, various changes to the Cell DTX cycle, the non-active duration, etc. could be made according to particular needs.

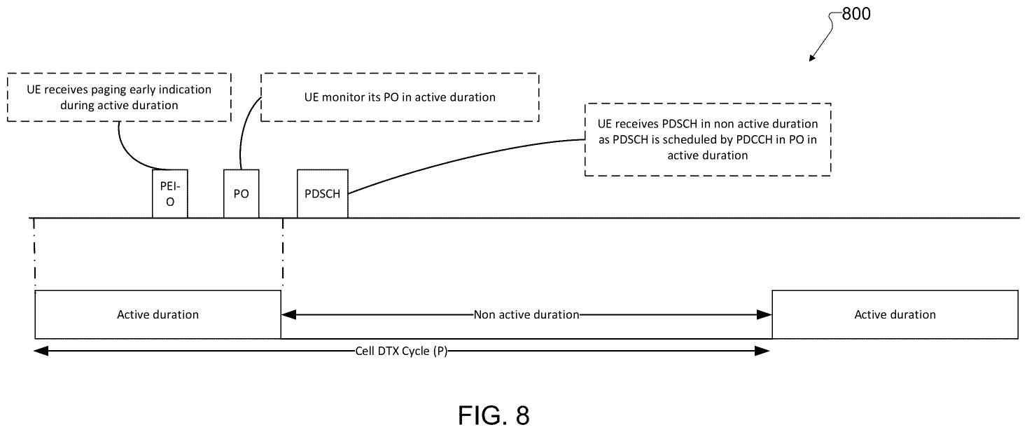

In one embodiment, if the UE's PEI-O is in an active duration of the Cell DTX cycle and UE receives a paging early indication (or paging early indication for its subgroup), the UE only monitors its PO in the non-active duration of the Cell DTX cycle as illustrated in FIG. 8.

FIG. 8 illustrates another example 800 of PO monitoring according to embodiments of the present disclosure. The embodiment of PO monitoring of FIG. 8 is for illustration only. Different embodiments of PO monitoring could be used without departing from the scope of this disclosure.

In the example of FIG. 8, the UE's PEI-O is in an active duration of the Cell DTX cycle. If the UE receives a paging early indication (or a paging early indication for its subgroup), the UE monitors its PO during the active duration of the Cell DTX cycle. If a PDCCH addressed to a P-RNTI scheduling a PDSCH paging message is received in the monitored PO, the UE receives the scheduled PDSCH even if the scheduled PDSCH is in the non-active duration of Cell DTX cycle.

Although FIG. 8 illustrates an example 800 of PO monitoring, various changes may be made to FIG. 8. For example, various changes to the Cell DTX cycle, the non-active duration, etc. could be made according to particular needs.

In one embodiment, the UE monitors its PO (in an active duration of the Cell DTX cycle as shown in FIG. 8 or in an inactive duration of the Cell DTX cycle as shown in FIG. 7). If a PDCCH addressed to a P-RNTI scheduling a PDSCH paging message is received in the monitored PO, the UE receives the scheduled PDSCH even if the scheduled PDSCH is in the non-active duration of the Cell DTX cycle as shown in FIGS. 7 and 8.

In one embodiment, if the UE's PEI-O partially overlaps with a non-active duration (e.g., one or more PDCCH monitoring occasions of the PEI-O are in the active duration and one or more PDCCH monitoring occasions of the PEI-O are in a non-active duration) of the Cell DTX cycle, the UE may not monitor the PEI-O. In another embodiment, if UE's PEI-O partially overlaps with the non-active duration of the Cell DTX cycle, the UE may monitor one or more PDCCH monitoring occasions in the part of PEI-O which is overlapping with the active duration or the UE may monitor one or more PDCCH monitoring occasions over the complete PEI-O (overlapping with the active duration and overlapping with the non-active duration).

In one embodiment (here it is assumed that PEI is not supported), if the UE's PO partially overlaps with the non-active duration (e.g., one or more PDCCH monitoring occasions of the PO are in the active duration and one or more PDCCH monitoring occasions of the PO are in the non-active duration) of the Cell DTX cycle, the UE may not monitor the PO. In another embodiment, if the UE's PO partially overlaps with non-active duration of the Cell DTX cycle, the UE may monitor one or more PDCCH monitoring occasions in the part of the PO which is overlapping with the active duration, or the UE may monitor one or more PDCCH monitoring occasions over the complete PO (overlapping with the active duration and overlapping with the non-active duration).

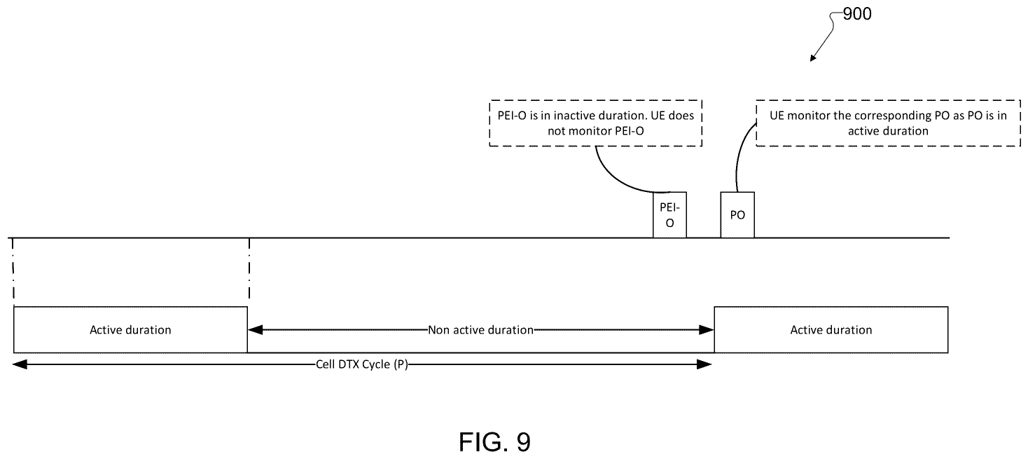

In one embodiment, if the UE does not monitor a PEI-O or is not able to monitor the PEI-O, due to partial or full overlap of the PEI-O with the non-active duration of the Cell DTX cycle, the UE monitors its PO if the PO corresponding to the not monitored PEI-O is in the active duration of the Cell DTX cycle as shown in FIG. 9.

FIG. 9 illustrates another example 900 of PO monitoring according to embodiments of the present disclosure. The embodiment of PO monitoring of FIG. 9 is for illustration only. Different embodiments of PO monitoring could be used without departing from the scope of this disclosure.

In the example of FIG. 9, the PEI-O is in the non-active duration of the Cell DTX cycle. The UE does not monitor the PEI-O. However, the UE monitors the corresponding PO that is in the active duration of the Cell DTX cycle.

Although FIG. 9 illustrates an example 900 of PO monitoring, various changes may be made to FIG. 9. For example, various changes to the Cell DTX cycle, the non-active duration, etc. could be made according to particular needs.

In one embodiment, if the PEI-O is partially or fully overlapped with the non-active duration of the Cell DTX cycle but the corresponding PO is in the active duration, the UE monitors the PEI-O. In one embodiment, if the PEI-O is partially or fully overlapped with the non-active duration of the Cell DTX cycle but the corresponding PO is in the active duration, the gNB may transmit a PEI in the PEI-O.

In one embodiment, the if UE supports one or more emergency SIBs (e.g., an ETWS/CMAS), if the UE's PF/PO overlaps with the Cell DTX cycle non-active duration, the UE monitors for paging in this PF/PO. Otherwise, if the UE's PF/PO overlaps with the Cell DTX cycle non-active duration, the UE does not monitor for paging in this PF/PO.

In one embodiment, during the non-active duration of the Cell DTX cycle:
ETWS or CMAS capable UEs in an RRC_INACTIVE or RRC_IDLE state shall monitor for an indication about a PWS notification in any paging occasion at least once every defaultPagingCycle (or emergency notification period (E), the emergency notification period can be one or multiple default DRX cycles); or
ETWS or CMAS capable UEs shall monitor for an indication about a PWS notification in any paging occasion at least once every defaultPagingCycle (or emergency notification period (E), the emergency notification period can be one or multiple default DRX cycles).

In one embodiment, during the non-active duration of the Cell DTX cycle:
UEs in an RRC_INACTIVE or RRC_IDLE state shall monitor for an SI change indication in any paging occasion at least once per modification period; or
UEs shall monitor for an SI change indication in any paging occasion at least once per modification period.

In one embodiment, during the Cell DTX cycle non-active duration, the UE may monitor specific PDCCH monitoring occasions (e.g., a separate search space can be configured for this) to receive an indication from the network to deactivate/terminate Cell DTX mode (i.e., the mode in which the UE is following active duration and non-active duration operation of the Cell DTX cycle) or terminate the Cell DTX non-active duration early or to receive an emergency notification.

In one embodiment, during the cell DTX cycle non-active duration, the UE can monitor for a LPWUS. The LP WUS can indicate whether to deactivate/terminate the Cell DTX mode (i.e., mode in which the UE is following an active duration and non-active duration operation of the Cell DTX cycle) or to terminate the Cell DTX non-active duration early or indicate an emergency notification. For example, if an emergency notification is received, the UE monitors SI window(s) to receive emergency SIBs(s), even during the cell DTX cycle non-active duration.

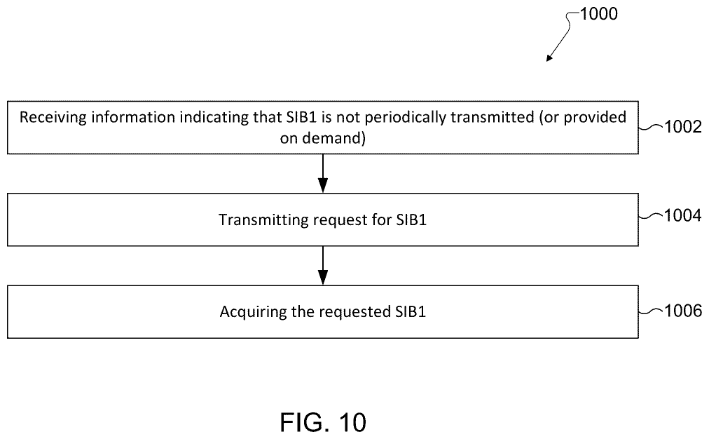

FIG. 10 illustrates an example UE operation to acquire SIB1 in a cell 1000 according to embodiments of the present disclosure. An embodiment of the operation illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments for a UE operation to acquire SIB1 in a cell could be used without departing from the scope of this disclosure.

In the example of FIG. 10, the UE operation begins at step 1002. At step 1002, a UE receives information indicating that SIB1 (or complete SIB1) is not periodically transmitted/broadcasted (or SIB1 is provided on demand) in the Cell (e.g., Cell A).

In one embodiment, the UE may receive this information in a MIB received from the Cell (i.e., Cell A). In one embodiment, the UE may receive this information in the payload of a PBCH received from the Cell (i.e., Cell A).

In one embodiment, the UE may receive this information in DCI of a PDCCH received in the Cell (i.e., Cell A). The DCI may indicate whether SIB1 is periodically broadcast or not (i.e., provided on demand or not). The PDCCH monitoring occasions of this DCI may be the same as PDCCH monitoring occasions for SIB1. Alternately, the PDCCH monitoring occasions of this DCI may be different from PDCCH monitoring occasions for SIB1 and can be configured or pre-defined with respect to the PDCCH monitoring occasions for SIB1 or with respect to a MIB/SSB. The RNTI used to scramble the CRC of this DCI can be different (and can be pre-defined) from the RNTI used to scramble the CRC of DCI scheduling SIB1. In one embodiment the RNTI can be an SI-RNTI. In one embodiment, the DCI which schedules SIB1 may indicate whether SIB1 is periodically broadcast or not (i.e., provided on demand or not).

In one embodiment, the Cell (e.g., Cell A) may broadcast a light SIB1 (which can also be referred by another name e.g., SIB A) which includes a SIB1 request configuration. This light SIB1 may not include most of the conventional configurations. If the UE receives the light SIB1 while acquiring SIB1, the UE can know that the UE can request for SIB1 or the UE can request for complete information of SIB1. The PDSCH scheduled by the PDCCH for SIB1 may include a light SIB1 instead of SIB1.

In one embodiment, the UE may receive this information from another Cell (e.g., neighboring cell, e.g., Cell B). Another cell (e.g., Cell B) may broadcast a list of one or more frequencies or carriers of cells not transmitting SIB1 periodically (or may broadcast a list of one or more frequencies or carriers of cells transmitting SIB1 on demand). If this list is received by the UE from a neighboring cell (Cell B) and the list includes the carrier/frequency of the cell (Cell A), the UE can know that the cell (i.e., Cell A) does not periodically transmit SIB1 (or provides SIB1 on demand). Another cell (e.g., Cell B) may broadcast a list of one or more cells not transmitting SIB1 periodically (or may broadcast a list of one or more frequencies or carriers of cells transmitting SIB1 on demand). If this list is received by the UE from the neighboring cell (Cell B) and the list includes the cell (Cell A), the UE can know that the cell (i.e., Cell A) does not periodically transmit SIB1 (or provides SIB1 on demand). Another cell (e.g., Cell B) may broadcast a list of one or more cells transmitting SIB1 periodically. If this list is received by the UE from a neighboring cell (Cell B) and list does not include the cell (Cell A), the UE can know that the cell (i.e., Cell A) does not periodically transmit SIB1 (or provides SIB1 on demand).

In one embodiment, if the SSB periodicity in the cell (i.e., Cell A) is greater than X ms, the UE assumes that SIB1 is not periodically transmitted (or SIB1 is provided on demand) in the cell (Cell A). X can be configurable or pre-defined.

In one embodiment, the UE assumes that SIB1 is not periodically transmitted (or SIB1 is provided on demand) in the cell (Cell A) if the cell supports a secondary MIB (which may be referred to as a light MIB or eMIB or additional MIB or any other name). Whether the secondary MIB is supported or not can be indicated in a MIB/SSB received from the cell.

In one embodiment, the UE assumes that SIB1 is not periodically transmitted (or SIB1 is provided on demand) in the cell (Cell A) if the cell supports a secondary SSB (which may be referred to as a light SSB or eSSB or additional SSB or any other name). Whether a secondary SSB is supported or not can be indicated in a MIB/SSB received from the cell.

In one embodiment, the UE E assumes that SIB1 is not periodically transmitted/broadcasted (or SIB1 is provided on demand) in the cell (Cell A) if the cell supports on demand SSB/MIB.

In one embodiment, the UE assumes that SIB1 is not periodically transmitted (or SIB1 is provided on demand) in the cell (Cell A) if the cell provides a configuration (e.g., in a MIB or via another cell) for a SIB1 request.

In one embodiment, the time and/or frequency location of an SSB transmitted in a cell can be different for periodic SIB1 transmission and on demand SIB1 transmission. Based on the time and/or frequency location of the SSB received in the cell, the UE can know that SIB1 is not periodically transmitted (or SIB1 is provided on demand) in the cell (Cell A).

In one embodiment, the PSS/SSS sequence transmitted in a cell can be different for periodic SIB1 transmission and on demand SIB1 transmission. Based on the PSS/SSS sequence received in the cell (Cell A), the UE can know that SIB1 is not periodically transmitted (or SIB1 is provided on demand) in the cell (Cell A).

In one embodiment, the UE may receive a list of one or more frequencies or carriers of cells not transmitting SIB1 periodically (or may receive a list of one or more frequencies or carriers of cells transmitting SIB1 on demand) in a dedicated RRC message (e.g., RRCRelease message or RRCReconfiguration message). If this list is received by the UE in a dedicated RRC message and the list includes the carrier/frequency of the cell (Cell A), the UE can know that the cell (i.e., Cell A) does not periodically transmit SIB1 (or provides SIB1 on demand).

In one embodiment, the UE may receive a list of one or more cells not transmitting SIB1 periodically (or may receive a list of one or more frequencies or carriers of cells transmitting SIB1 on demand) in a dedicated RRC message (e.g., RRCRelease message or RRCReconfiguration message). If this list is received by the UE in the dedicated RRC message (e.g., RRCRelease message or RRCReconfiguration message) and the list includes the cell (Cell A), the UE can know that the cell (i.e., Cell A) does not periodically transmit SIB1 (or provides SIB1 on demand).

In one embodiment, the UE assumes that SIB1 is not periodically transmitted (or SIB1 is provided on demand) in the cell (Cell A), if Cell A is not a camping cell but an access cell. Access cell means that the UE uses the cell only when it wants to access i.e., resume connection or establish connection with network.

In one embodiment, whether SIB1 is periodically transmitted (or SIB1 is provided on demand) can be indicated in a paging message or short message or paging DCI received in the cell (Cell A).

At step 1004, if the cell (Cell A) does not periodically transmit SIB1 (or transmits only a light SIB1), the UE may transmit a request for SIB1 (or complete SIB1) to the network (e.g., a base station or gNB) using the SIB1 request configuration.

In one embodiment, the UE may transmit a PRACH preamble towards the cell (Cell A) to request for SIB1 (or complete SIB1).

In one embodiment, the UE may transmit an UL low power wakeup signal towards the cell (Cell A) to request for SIB1 (or complete SIB1).

In one embodiment, the UE may transmit a MsgA towards the cell (Cell A) to request for SIB1 (or complete SIB1).

In one embodiment, the UE may initiate a random access procedure towards the cell (Cell A) to request for SIB1 (or complete SIB1). During the random access procedure an RRC message or MAC CE may be included in a Msg3 or MsgA which indicates the request for SIB1.

In one embodiment, UE may transmit a PRACH preamble/MsgA/UL low power wakeup signal/Msg3/Random access procedure towards another cell (Cell B) to request SIB1 of the cell (Cell A).

In one embodiment, the UE may transmit a scheduling request or PUCCH towards the cell (Cell A) to request for SIB1 (or complete SIB1).

In one embodiment, the SIB1 request configuration (e.g., RACH configuration or UL low power wakeup signal or PUCCH) for transmitting the request for SIB1 can be a pre-defined/default configuration.

In one embodiment, the SIB1 request configuration (e.g., RACH configuration or UL low power wakeup signal) for transmitting the request for SIB1 can be acquired via another cell (the SIB1 request configuration can be per cell, per frequency [e.g. ARFCN], can be common for all cells of SI Area [the SIB1 request configuration can be associated with an SI area/SI area identifier] or RAN notification area [the SIB1 request configuration can be associated with a RAN notification area]).

In one embodiment, a MIB of the cell (cell A) may indicate the cell(s)/carrier(s) from which to obtain the SIB1 request configuration of the cell (cell A).

In one embodiment, another cell (e.g., Cell B) may broadcast a SIB1 request configuration for a list of one or more frequencies or carriers of cells not transmitting SIB1 periodically (or may broadcast a list of one or more frequencies or carriers of cells transmitting SIB1 on demand). The UE may acquire this information from another cell.

In one embodiment, another cell (e.g., Cell B) may broadcast a SIB1 request configuration of one or more cells not transmitting SIB1 periodically (or providing SIB1 on demand). The UE may acquire this information from another cell.

In one embodiment, the configuration can be valid for a specified time (e.g., based on a validity timer). The UE may start a validity timer upon acquiring the SIB1 request configuration. The UE uses the acquired information while the validity timer is running. Upon expiry of the validity timer, the acquired information is discarded.

In one embodiment, the SIB1 request configuration acquired from another cell (e.g., Cell B) belonging to SI area with SI area identifier X is valid in any cell belonging to the SI area identifier X. If Cell A has the same SI area identifier as Cell B, the UE uses the SIB1 request configuration acquired from Cell B. If Cell A is associated with SI area identifier X, the UE uses/selects the SIB1 request configuration associated with SI area identifier X for requesting SIB1 of Cell A.

In one embodiment, the SIB1 request configuration acquired from Cell B belonging to a RAN area is valid in any cell belonging to that RAN area i.e., the RAN area to which Cell B belongs. If Cell A belongs to same RAN area as Cell B, the UE uses the SIB1 request configuration acquired from Cell B.

In one embodiment, the SIB1 request configuration is associated with list of one or more cells, the association is signaled, and the acquired SIB1 request configuration can be used in any of the associated cells.

In one embodiment, the SIB1 request configuration (e.g., RACH configuration or UL low power wakeup signal or PUCCH) for transmitting the request for SIB1 can be acquired from a MIB/SSB or secondary MIB/SSB.

In one embodiment, the SIB1 request configuration (e.g., RACH configuration or UL low power wakeup signal) for transmitting the request for SIB1 can be acquired from a light SIB1.

In one embodiment, for a SIB1 request based on a RACH, the SIB1 request configuration may include one or more of the following:
A list of one or more random access preambles. In one embodiment, ra-Preamble StartIndex for the SIB1 request can be included. If N SSBs are associated with a RACH occasion, where N>=1, for the i-th SSB (i=0, . . . , N-1) the preamble with preamble index=ra-PreambleStartIndex+i is used for SIB1 request; For N<1, the preamble with preamble index=ra-PreambleStartIndex is used for SIB1 request.
In one embodiment, sib1-RequestPeriod and ra-AssociationPeriodIndex can be included for the SIB1 request. Sib1-RequestPeriod can be periodicity of the SIB1 request in a number of association periods. ra-AssociationPeriodIndex is the index of the association period in the sib1-RequestPeriod in which the UE can send the SIB1 request, using the preambles indicated by ra-PreambleStartIndex.
A list of one or more random access occasions

In one embodiment, for a SIB1 request based on an uplink low power wakeup signal, the SIB1 request configuration may include one or more of a list of one or more LP WUS sequences, LP WUS occasions (time and/or frequency), a periodicity etc.

In one embodiment, for a SIB1 request based on a PUCCH, the SIB1 request configuration may include one or more of a list of one or more PUCCH resources, an SR configuration for the SIB1 request etc.

At step 1006, upon transmitting the SIB1 request, the UE acquires the requested SIB1 (or complete SIB1). In one embodiment, the UE acquires the requested SIB1 upon receiving an acknowledgement of the SIB1 request from the network. In case of a RACH based SIB1 request, they acknowledgement can be a Msg2 or Msg4. The Msg2 may include a RAR for the transmitted random access preamble ID. The Msg4 may include a contention resolution MAC CE.

In one embodiment, for acquiring the requested SIB1, the UE monitors PDCCH monitoring occasions of the SIB1 (e.g., as configured by a MIB or light SIB1). These PDCCH monitoring occasions can be the same as the PDCCH monitoring occasions for receiving a periodically transmitted SIB1. These PDCCH monitoring occasions can be different from the PDCCH monitoring occasions for receiving a periodically transmitted SIB1. In one embodiment, for acquiring the SIB1, the UE monitors PDCCH monitoring occasions of the SIB1 in a monitoring window. The length of the monitoring window and the start of the monitoring window can be configurable. The monitoring window can start at an offset from the end of the occasion in which the SIB1 request is transmitted (or start at the first PDCCH monitoring occasion which is at least one symbol away from the end of the occasion in which the SIB1 request is transmitted). The monitoring window can start at an offset from the end of the occasion in which an acknowledgment for the SIB1 request is received (or start at the first PDCCH monitoring occasion which is at least one symbol away from the end of the occasion in which an acknowledgment for the SIB1 request is received).

In one embodiment, if the UE is able to acquire a light SIB1 from the cell but fails to acquire the complete SIB1 from the cell (or if the UE fails to acquire an on demand SIB1), the UE bars the cell. The UE may bar the frequency of the cell if the intra frequency reselection bit in a MIB is set to not allowed. The UE does not bar the frequency of the cell if the intra frequency reselection bit in the MIB is set to allowed.

Although FIG. 10 illustrates one example UE operation to acquire SIB1 in a cell 1000, various changes may be made to FIG. 10. For example, while shown as a series of steps, various steps in FIG. 10 could overlap, occur in parallel, occur in a different order, occur any number of times, be omitted, or replaced by other steps.

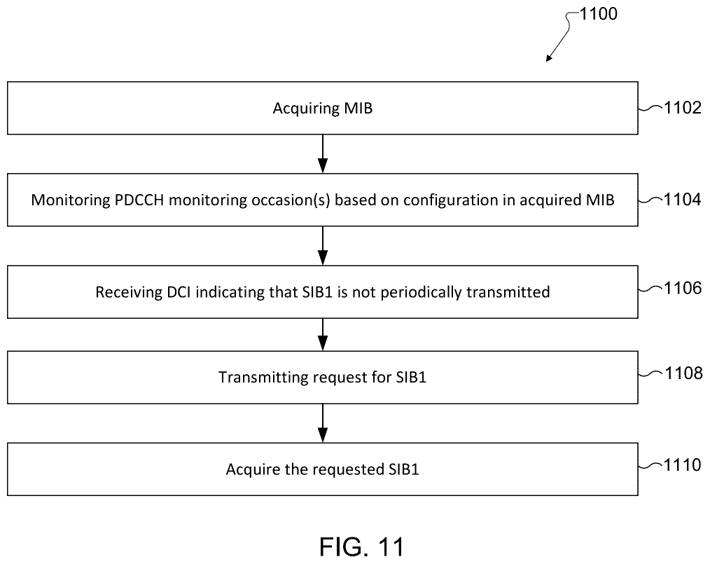

FIG. 11 illustrates another example UE operation to acquire SIB1 in a cell 1100 according to embodiments of the present disclosure. An embodiment of the operation illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments for a UE operation to acquire SIB1 in a cell could be used without departing from the scope of this disclosure.

In the example of FIG. 11, the UE operation begins at step 1102. At step 1102, a UE acquires the MIB of the Cell.

At step 1104, the UE monitors PDCCH monitoring occasion(s) based on a configuration in the acquired MIB. The DCI may indicate whether SIB1 is periodically broadcast or not (i.e., provided on demand). The PDCCH monitoring occasions of this DCI may be the same as PDCCH monitoring occasions for SIB1. Alternately, the PDCCH monitoring occasions of this DCI may be different from the PDCCH monitoring occasions for SIB1 and can be configured or pre-defined with respect to the PDCCH monitoring occasions for SIB1 or with respect to the MIB. The RNTI used to scramble CRC of this DCI can be different (and can be pre-defined) from the RNTI used to scramble the CRC of the DCI scheduling SIB1. In one embodiment, the DCI which schedules SIB1 may indicate whether SIB1 is periodically broadcast or not (i.e., provided on demand).

At step 1106, in the monitored occasions, UE receives DCI indicating that SIB1 is not periodically transmitted.

At step 1108, the UE transmits a request for SIB1. The operation is the same as step 1004 of FIG. 10.

At step 1110, upon transmitting the SIB1 request, the UE acquires the requested SIB1. The operation is same as step 1006 of FIG. 10.

Although FIG. 11 illustrates one example UE operation to acquire SIB1 in a cell 1100, various changes may be made to FIG. 11. For example, while shown as a series of steps, various steps in FIG. 11 could overlap, occur in parallel, occur in a different order, occur any number of times, be omitted, or replaced by other steps.

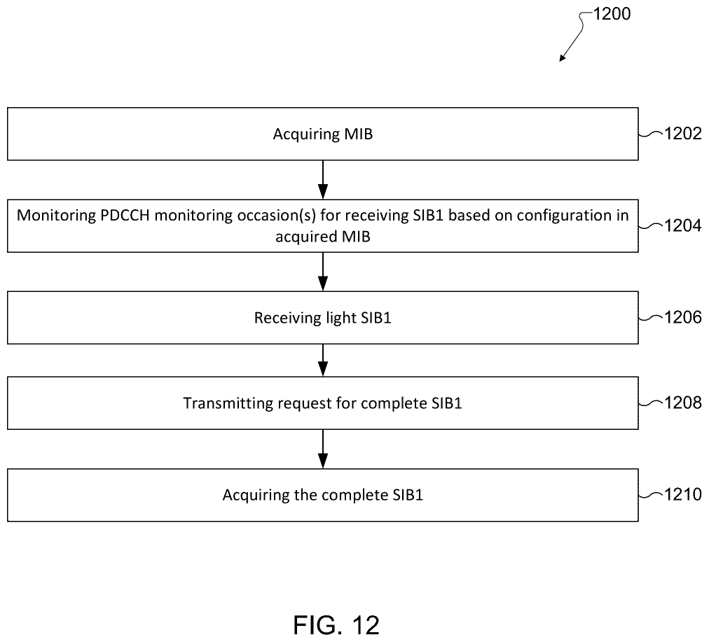

FIG. 12 illustrates another example UE operation to acquire SIB1 in a cell 1200 according to embodiments of the present disclosure. An embodiment of the operation illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments for a UE operation to acquire SIB1 in a cell could be used without departing from the scope of this disclosure.

In the example of FIG. 12, the UE operation begins at step 1202. At step 1202, a UE acquires the MIB of the Cell.

At step 1204, the UE monitors PDCCH monitoring occasion(s) based on the configuration in the acquired MIB.

The Cell may broadcast a light SIB1 (which can also be referred by another name e.g., SIB A) which includes a SIB1 request configuration. This light SIB1 does not include most of the conventional configurations. If the UE receives the light SIB1 while acquiring the SIB1, the UE can know that the UE can request for SIB1 or the UE can request for complete information of SIB1. The PDSCH scheduled by the PDCCH for SIB1 may include a light SIB1 instead of SIB1.

At step 1206, in the monitored occasions, the UE receives DCI scheduling a PDSCH. The UE receives the light SIB1 in PDSCH.

At step 1208, the UE transmits a request for SIB1 using the SIB1 request configuration in the light SIB1. The details of the SIB1 request configuration are the same as step 1004 of FIG. 10.

At step 1210, upon transmitting the SIB1 request, the UE acquires the requested SIB1. The operation is the same as step 1006 of FIG. 10.

Although FIG. 12 illustrates one example UE operation to acquire SIB1 in a cell 1200, various changes may be made to FIG. 12. For example, while shown as a series of steps, various steps in FIG. 12 could overlap, occur in parallel, occur in a different order, occur any number of times, be omitted, or replaced by other steps.

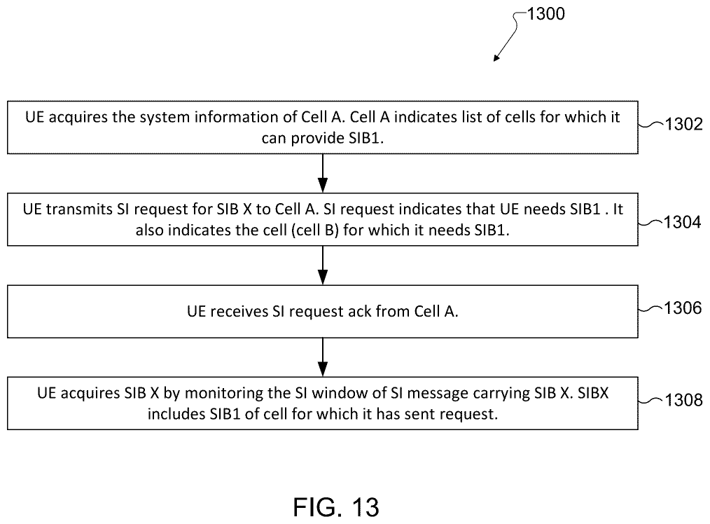

FIG. 13 illustrates another example UE operation to acquire SIB1 in a cell 1300 according to embodiments of the present disclosure. An embodiment of the operation illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments for a UE operation to acquire SIB1 in a cell could be used without departing from the scope of this disclosure.

In the example of FIG. 13, the UE operation begins at step 1302. At step 1302, A UE acquires the system information of a Cell “A”. Cell A indicates a list of cells for which it can provide SIB1. SIB1s of other cells are provided in a new SIB (e.g., SIB X) by Cell A.

At step 1304, the UE transmits an SI request for SIB X to Cell A. The SI request indicates that the UE needs SIB1 of another cell (i.e., the UE needs SIBx including SIB1 of another cell). It also indicates the cell (e.g., Cell B) for which it needs SIB1.

At step 1306, the UE receives an SI request ack from Cell A.

At step 1308, the UE acquires SIB X from Cell A by monitoring the SI window of an SI message carrying SIB X and obtains the SIB1 of the cell for which it has sent the request from SIBX. Note that SIBX may include a SIB1 of multiple cell(s). The Cell ID is included in SIBX to associate each SIB1 in SIBX to a cell.

The acquired configuration can be valid for a specified time (e.g., based on a validity timer) or the UE can check the validity based on a valueTag when it (re) selects to Cell B. The MIB of Cell B can indicate the valueTag of SIB1 used in Cell B. If the valueTag of SIB1 of Cell B acquired from Cell A is the same as the valueTag of SIB1 in the MIB of Cell B, the UE can use the SIB1 in Cell B. If the validity timer of SIB1 of Cell B acquired from Cell A is running, the UE can use the SIB1 in Cell B.

Although FIG. 13 illustrates one example UE operation to acquire SIB1 in a cell 1300, various changes may be made to FIG. 13. For example, while shown as a series of steps, various steps in FIG. 13 could overlap, occur in parallel, occur in a different order, occur any number of times, be omitted, or replaced by other steps.

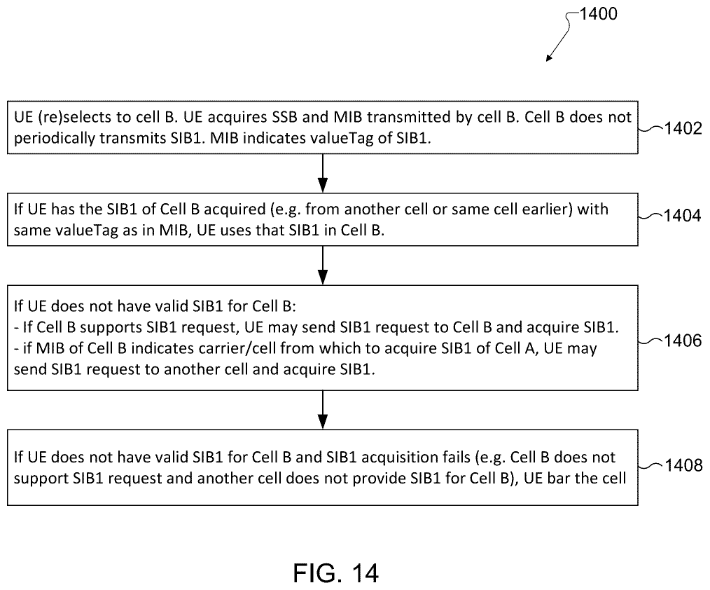

FIG. 14 illustrates another example UE operation to acquire SIB1 in a cell 1400 according to embodiments of the present disclosure. An embodiment of the operation illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments for a UE operation to acquire SIB1 in a cell could be used without departing from the scope of this disclosure.

In the example of FIG. 14, the UE operation begins at step 1402. At step 1402, the UE (re) selects to a cell “B”. The UE acquires SSB(s) and a MIB transmitted by Cell B. Cell B does not periodically transmit SIB1. The UE may determine this as explained earlier herein. The MIB indicates a valueTag of SIB1.

At step 1404, if the UE has the SIB1 of Cell B acquired (e.g., from another cell or the same cell earlier) with the same valueTag as in the MIB, the UE uses that SIB1 in Cell B.

At step 1406, if the UE does not have a valid SIB1 for Cell B:
If Cell B supports SIB1 requests, the UE may send a SIB1 request to Cell B and acquire SIB1.
If the MIB of Cell B indicates a carrier/cell from which to acquire SIB1 of Cell B, the UE may send a SIB1 request to another cell (Cell A) and acquire SIB1 (Cell A may trigger Cell B to transmit SIB1 upon receiving the request from the UE or alternately Cell A provides the SIB1 of Cell B upon receiving request from the UE. Cell A may obtain SIB1 of Cell B from Cell B).

At step 1408, if the UE does not have a valid SIB1 for Cell B and the SIB1 acquisition fails (e.g., Cell B does not support SIB1 requests and another cell does not provide the SIB1 for Cell B), the UE bars the cell.

Although FIG. 14 illustrates one example UE operation to acquire SIB1 in a cell 1400, various changes may be made to FIG. 14. For example, while shown as a series of steps, various steps in FIG. 14 could overlap, occur in parallel, occur in a different order, occur any number of times, be omitted, or replaced by other steps.

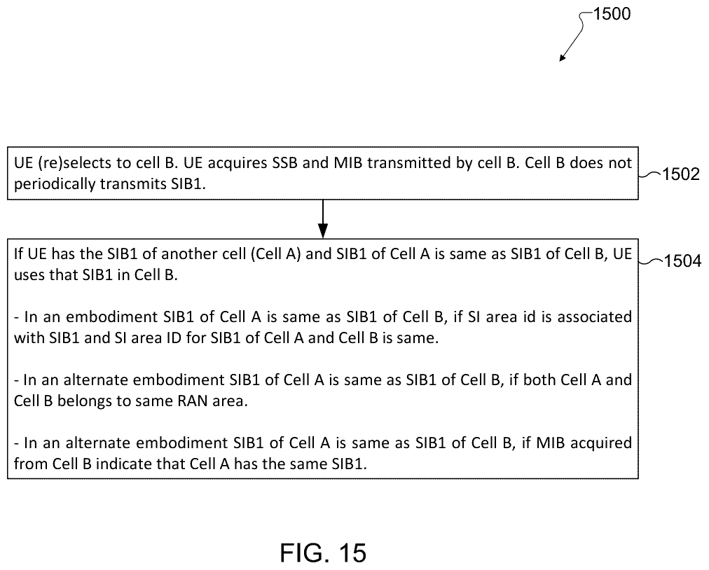

FIG. 15 illustrates another example UE operation to acquire SIB1 in a cell 1500 according to embodiments of the present disclosure. An embodiment of the operation illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments for a UE operation to acquire SIB1 in a cell could be used without departing from the scope of this disclosure.

In the example of FIG. 15, the UE operation begins at step 1502. At step 1502, a UE (re) selects to a cell “B”. The UE acquires SSB(s) and a MIB transmitted by Cell B. Cell B does not periodically transmit SIB1. The UE may determine this as explained earlier herein.

At step 1504, if the UE has the SIB1 of another cell (Cell A) and the SIB1 of Cell A is the same as SIB1 of Cell B, the UE uses that SIB1 in Cell B. In one embodiment SIB1 of Cell A is the same as SIB1 of Cell B, if an SI area ID is associated with SIB1 and the SI area ID for SIB1 of Cell A and Cell B is the same. In one embodiment SIB1 of Cell A is the same as SIB1 of Cell B if both Cell A and Cell B belong to the same RAN area. In one embodiment, SIB1 of Cell A is the same as SIB1 of Cell B if a MIB acquired from Cell B indicates that Cell A has the same SIB1.

If the UE does not have valid SIB1 for Cell B:
If Cell B supports SIB1 requests, the UE may send a SIB1 request to Cell B and acquire SIB1.
If the MIB of Cell B indicates a carrier/cell from which to acquire SIB1 of Cell B, the UE may send a SIB1 request to another cell (Cell A) and acquire SIB1 (Cell A may trigger Cell B to transmit SIB1 upon receiving the request from UE or alternately Cell A provides the SIB1 of Cell B upon receiving request from UE. Cell A may obtain SIB1 of Cell B from Cell B).

If the UE does not have a valid SIB1 for Cell B and the SIB1 acquisition fails (e.g., Cell B does not support SIB1 requests and another cell does not provide SIB1 for Cell B), the UE bars the cell.

Although FIG. 15 illustrates one example UE operation to acquire SIB1 in a cell 1500, various changes may be made to FIG. 15. For example, while shown as a series of steps, various steps in FIG. 15 could overlap, occur in parallel, occur in a different order, occur any number of times, be omitted, or replaced by other steps.

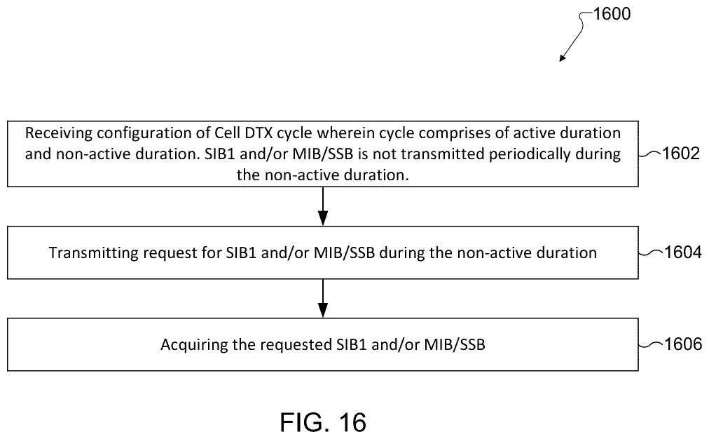

FIG. 16 illustrates an example UE operation to acquire SIB1 and/or a MIB/SSB during a non-active duration in a cell 1600 according to embodiments of the present disclosure. An embodiment of the operation illustrated in FIG. 16 is for illustration only. One or more of the components illustrated in FIG. 16 may be implemented in specialized circuitry configured to perform the noted functions or one or more of the components may be implemented by one or more processors executing instructions to perform the noted functions. Other embodiments for a UE operation to acquire SIB1 and/or a MIB/SSB during a non-active duration in a cell could be used without departing from the scope of this disclosure.

In the example of FIG. 16, the UE operation begins at step 1602. At step 1602, a UE is in coverage of a cell (e.g., Cell A). the UE receives the configuration of periodic Cell DTX cycle of Cell A, wherein the cycle comprises an active duration and non-active duration. During the non-active duration, Cell A does not transmit SIB1 and/or a MIB/SSB periodically.

The Periodic cell DTX pattern may be configured by a ‘duration’ and ‘period’ field wherein during the ‘duration’ interval which occurs periodically every ‘period’, the cell does not perform transmission. Alternately, a periodic cell DTX pattern may be configured by a ‘duration’ and ‘period’ field wherein during the ‘duration’ interval which occurs periodically every ‘period’, the cell performs transmission and during the interval ‘period-duration’ the cell does not perform transmission (or stops certain transmissions) as explained earlier herein. The period/time where the cell does not perform transmission is called the inactive period/time.

The UE may seek to obtain the latest SIB1 and/or MIB/SSB during the non-active duration, for example to access the cell for mobile originated data or signaling transmission, or for responding to paging or to receive emergency SIBs.

At step 1604, the UE may transmit a request for SIB1 and/or a MIB/SSB to the network (e.g., base station or gNB) using the SIB1 and/or MIB/SSB request configuration.

In one embodiment, the UE may transmit a PRACH preamble towards the cell (Cell A) to request for SIB1 and/or the MIB/SSB. The PRACH preamble can be different for the SIB1 and the MIB/SSB request or it can be common for the SIB1 and the MIB/SSB request.

In one embodiment, the UE may transmit an UL low power wakeup signal towards the cell (Cell A) to request for SIB1 and/or the MIB/SSB.

In one embodiment, the UE may transmit a MsgA towards the cell (Cell A) to request for SIB1 and/or the MIB/SSB. The MsgA may indicate whether the request is for SIB1 and/or the MIB/SSB.

In one embodiment, the UE may initiate a random access procedure towards the cell (Cell A) to request for SIB1 and/or the MIB/SSB. During the random access procedure, an RRC message or MAC CE may be included in a Msg3 or MsgA which indicates the request for SIB1 and/or the MIB/SSB.

In one embodiment, the UE may transmit a PRACH preamble/MsgA/UL low power wakeup signal/Msg3/random access procedure towards another cell (Cell B) to request SIB1 and/or the MIB/SSB of the cell (Cell A).

In one embodiment, the UE may transmit a scheduling request or PUCCH towards the cell (Cell A) to request for SIB1 and/or the MIB/SSB.

In one embodiment, the SIB1 and/or MIB/SSB request configuration (e.g., RACH configuration or UL low power wakeup signal) for transmitting the request for SIB1 and/or the MIB/SSB can be a pre-defined/default configuration.

In one embodiment, the SIB1 and/or MIB/SSB request configuration (e.g., RACH configuration or UL low power wakeup signal) for transmitting the request for SIB1 and/or the MIB/SSB can be obtained from a SIB1 of the cell (Cell A) acquired earlier.

In one embodiment, the SIB1 and/or MIB/SSB request configuration (e.g., RACH configuration or UL low power wakeup signal) for transmitting the request for SIB1 and/or the MIB/SSB can be acquired via another cell (the configuration can be per cell and/or per frequency, and can be common for all cells of an SI Area or a RAN notification area).

In one embodiment, another cell (e.g., Cell B) may broadcast a SIB1 and/or MIB/SSB request configuration for a list of one or more frequencies or carriers of cells.

In one embodiment, another cell (e.g., Cell B) may broadcast a SIB1 and/or MIB/SSB request configuration of one or more cells.

In one embodiment, the configuration can be valid for a specified time (e.g., based on a validity timer). The UE may start the validity timer upon acquiring the SIB1 and/or MIB/SSB request configuration. The UE uses the acquired information while the validity timer is running. Upon expiry of validity timer, the acquired information is discarded.

In one embodiment, the SIB1 and/or MIB/SSB request configuration acquired from cell B belonging to an SI area with SI area identifier X is valid in any cell belonging to the SI area identifier X. If Cell A has the same SI area identifier as Cell B, the UE uses the SIB1 and/or MIB/SSB request configuration acquired from cell B. If Cell A is associated with SI area identifier X, the UE uses/selects the SIB1 and/or MIB/SSB request configuration associated with SI area identifier X.

In one embodiment, the SIB1 and/or MIB/SSB request configuration acquired from cell B belonging to a RAN area is valid in any cell belonging to that RAN area i.e., the RAN area to which cell B belongs. If Cell A belongs to same RAN area as Cell B, the UE uses the SIB1 and/or MIB/SSB request configuration acquired from cell B.

In one embodiment, the SIB1 and/or MIB/SSB request configuration is associated with a list of one or more cells, the association is signaled, and the acquired SIB1 request configuration can be used in any of the associated cells.

In one embodiment, the SIB1 and/or MIB/SSB request configuration (e.g., RACH configuration or UL low power wakeup signal) for transmitting the request for SIB1 and/or the MIB/SSB can be acquired from a MIB/SSB or secondary MIB/SSB.

In one embodiment, for the SIB1 and/or MIB/SSB request based on a RACH, the SIB1 and/or MIB/SSB request configuration may include one or more of the following:
A list of one or more random access preambles. In one embodiment, ra-PreambleStartIndex for SIB1 and/or MIB/SSB request can be included. If N SSBs are associated with a RACH occasion, where N>=1, for the i-th SSB (i=0, . . . , N-1) the preamble with preamble index=ra-PreambleStartIndex+i is used for SIB1 and/or MIB/SSB request; For N<1, the preamble with preamble index=ra-PreambleStartIndex is used for SIB1 and/or MIB/SSB request.
In one embodiment, sib1-RequestPeriod and ra-AssociationPeriodIndex can be included for SIB1 request. Sib1-RequestPeriod can be periodicity of the SIB1 and/or MIB/SSB request in number of association periods. ra-AssociationPeriodIndex is the index of the association period in the sib1-RequestPeriod in which the UE can send the SIB1 and/or MIB/SSB request, using the preambles indicated by ra-Preamble StartIndex.
A list of one or more random access occasions

In one embodiment, for a SIB1 and/or MIB/SSB request based on an uplink low power wakeup signal, the SIB1 and/or MIB/SSB request configuration may include one or more of a list of one or more LP WUS sequences, LP WUS occasions (time and/or frequency), periodicity etc.

In one embodiment, for a SIB1 and/or MIB/SSB request based on a PUCCH, the SIB1 and/or MIB/SSB request configuration may include one or more of a list of one or more PUCCH resources, an SR configuration for the SIB1 and/or MIB/SSB request etc.

At step 1606, upon transmitting the SIB1 and/or MIB/SSB request, the UE acquires the requested SIB1 and/or MIB/SSB. In one embodiment, the UE acquires the requested SIB1 and/or MIB/SSB upon receiving the acknowledgement of the SIB1 and/or MIB/SSB request from the network. In case of a RACH based SIB1 and/or MIB/SSB request, the acknowledgement can be a Msg2 or Msg4. The Msg2 may include a RAR for the transmitted random access preamble ID. The Msg4 may include a contention resolution MAC CE.

In one embodiment, for acquiring the requested SIB1, the UE monitors PDCCH monitoring occasions of SIB1 (as configured by the MIB). These PDCCH monitoring occasions can be the same as the PDCCH monitoring occasions for receiving the periodically transmitted SIB1. These PDCCH monitoring occasions can be different from the PDCCH monitoring occasions for receiving the periodically transmitted SIB1. In one embodiment, for acquiring SIB1, the UE monitors PDCCH monitoring occasions of SIB1 in a monitoring window. The length of the monitoring window and start of the monitoring window can be configurable. The monitoring window can start at an offset from the end of the occasion in which the SIB1 request is transmitted (or start at the first PDCCH monitoring occasion which is at least one symbol away from the end of the occasion in which the SIB1 request is transmitted). The monitoring window can start at an offset from the end of the occasion in which an acknowledgment for the SIB1 request is received (or start at the first PDCCH monitoring occasion which is at least one symbol away from the end of the occasion in which the acknowledgment for the SIB1 request is received).

In one embodiment, for acquiring the requested MIB/SSB, the UE monitors a monitoring window. The length of the monitoring window and start of the monitoring window can be configurable. The monitoring window can start at an offset from the end of occasion in which the request is transmitted. The monitoring window can start at an offset from the end of the occasion in which an acknowledgment for the SIB1 request is received.

Although FIG. 16 illustrates one example UE operation to acquire SIB1 and/or a MIB/SSB during a non-active duration in a cell 1600, various changes may be made to FIG. 16. For example, while shown as a series of steps, various steps in FIG. 16 could overlap, occur in parallel, occur in a different order, occur any number of times, be omitted, or replaced by other steps.

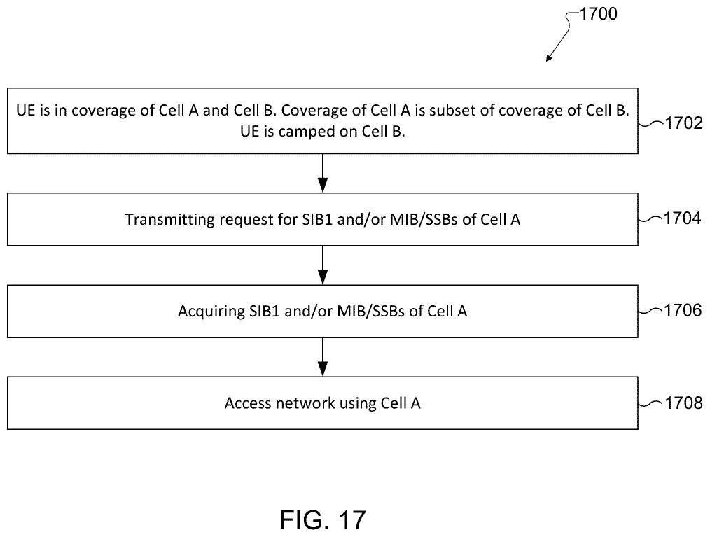

FIG. 17 illustrates an example UE operation to acquire SIB1 and/or a MIB/SSB 1700 according to embodiments of the present disclosure. An embodiment of the operation illustrated in FIG. 17 is for illustration only. One or more of the components illustrated in FIG. 17 may be implemented in specialized circuitry configured to perform the noted functions or one or more of the components may be implemented by one or more processors executing instructions to perform the noted functions. Other embodiments for a UE operation to acquire SIB1 and/or a MIB/SSB during the non-active duration in a cell could be used without departing from the scope of this disclosure.

In the example of FIG. 17, the UE operation begins at step 1702. At step 1702, a UE is in coverage of a Cell “A” and a Cell “B”. The coverage of Cell A is a subset of the coverage of Cell B. Cell B can be a macro cell and Cell A can be a small cell in the coverage of Cell B. The UE is camped on Cell B (which can also be referred as an anchor cell). Cell A can be referred as an access cell. When the UE needs to access the network (e.g., to resume a connection or setup a connection or for data transmission and reception), the UE performs a random access towards Cell A. Cell A may not transmit periodic signals such as SSBs/MIB/SIB1 etc. to reduce energy consumption or may transmit them at very long periodicity to reduce energy consumption.

Before the UE can access network or perform the random access towards Cell A, the UE may seek to obtain the latest SIB1 and/or MIB/SSB of Cell A.

At step 1704, the UE may transmit request for SIB1 and/or MIB/SSB to network (e.g., base station or gNB) using the SIB1 and/or MIB/SSB request configuration.

In one embodiment, the UE may transmit a PRACH preamble towards the Cell A to request for SIB1 and/or a MIB/SSB.

In one embodiment, the UE may transmit an UL low power wakeup signal towards the Cell A to request for SIB1 and/or a MIB/SSB.

In one embodiment, the UE may transmit a MsgA towards the Cell A to request for SIB1 and/or a MIB/SSB.

In one embodiment, the UE may initiate a random access procedure towards the Cell A to request for SIB1 and/or a MIB/SSB. During the random access procedure an RRC message or MAC CE may be included in a Msg3 or a MsgA which indicates the request for SIB1 and/or a MIB/SSB.

In one embodiment, the UE may transmit a scheduling request or PUCCH towards the Cell A to request for SIB1 and/or a MIB/SSB.

In one embodiment, the UE may transmit a PRACH preamble/MsgA/UL low power wakeup signal/Msg3/Random access procedure/PUCCH towards Cell B to request SIB1 and/or a MIB/SSB of the Cell A. The request may include an identity (e.g., PCI, CGI etc.) of Cell A. Cell B can request Cell A to start transmitting SIB1 and/or a MIB/SSBs.

The SIB1 and/or MIB/SSB request can also be referred as request to wake up or request to access the cell.

In one embodiment, the SIB1 and/or MIB/SSB request configuration (e.g., RACH configuration or UL low power wakeup signal or PUCCH) for transmitting the request for SIB1 and/or a MIB/SSB can be a pre-defined/default configuration.

In one embodiment, the SIB1 and/or MIB/SSB request configuration (e.g., RACH configuration or UL low power wakeup signal or PUCCH) for transmitting the request for SIB1 and/or a MIB/SSB can be acquired from Cell B.

In one embodiment, Cell B may broadcast a SIB1 and/or MIB/SSB request configuration for a list of one or more frequencies or carriers of cells in coverage of Cell B.

In one embodiment, Cell B may broadcast a SIB1 and/or MIB/SSB request configuration of one or more cells in coverage of Cell B.

In one embodiment, the configuration can be valid for a specified time (e.g., based on a validity timer). The UE may start the validity timer upon acquiring the SIB1 and/or MIB/SSB request configuration. The UE uses the acquired information while the validity timer is running. Upon expiry of validity timer, the acquired information is discarded.

In one embodiment, the SIB1 and/or MIB/SSB request configuration acquired from Cell B belonging to an SI area with SI area identifier X is valid in any cell belonging to the SI area identifier X. If Cell A has the same SI area identifier as Cell B, the UE uses the SIB1 and/or MIB/SSB request configuration acquired from Cell B. If Cell A is associated with SI area identifier X, the UE uses/selects the SIB1 and/or MIB/SSB request configuration associated with SI area identifier X.

In one embodiment, the SIB1 and/or MIB/SSB request configuration acquired from Cell B belonging to a RAN area is valid in any cell belonging to that RAN area i.e., the RAN area to which cell B belongs. If Cell A belongs to same RAN area as Cell B, the UE uses the SIB1 and/or MIB/SSB request configuration acquired from Cell B.

In one embodiment, the SIB1 and/or MIB/SSB request configuration is associated with a list of one or more cells, an association is signaled, and the acquired SIB1 request configuration can be used in any of the associated cells.

In one embodiment, for SIB1 and/or MIB/SSB request based on RACH, SIB1 and/or MIB/SSB request configuration may include one or more of the following:
A list of one or more random access preambles. In one embodiment, ra-Preamble StartIndex for the SIB1 and/or MIB/SSB request can be included. If N SSBs are associated with a RACH occasion, where N>=1, for the i-th SSB (i=0, . . . , N-1) the preamble with preamble index=ra-PreambleStartIndex+i is used for SIB1 and/or MIB/SSB request; For N<1, the preamble with preamble index=ra-PreambleStartIndex is used for SIB1 and/or MIB/SSB request.
In one embodiment, sib1-RequestPeriod and ra-AssociationPeriodIndex can be included for the SIB1 request. Sib1-RequestPeriod can be periodicity of the SIB1 and/or MIB/SSB request in number of association periods. ra-AssociationPeriodIndex is the index of the association period in the sib1-RequestPeriod in which the UE can send the SIB1 and/or MIB/SSB request, using the preambles indicated by ra-Preamble StartIndex.
A list of one or more random access occasions

In one embodiment, for a SIB1 and/or MIB/SSB request based on an uplink low power wakeup signal, the SIB1 and/or MIB/SSB request configuration may include one or more of a list of one or more LP WUS sequences, LP WUS occasions (time and/or frequency), periodicity, etc.

In one embodiment, for a SIB1 and/or MIB/SSB request based on a PUCCH, the SIB1 and/or MIB/SSB request configuration may include one or more of a list of one or more PUCCH resources, an SR configuration for the SIB1 and/or MIB/SSB request etc.

In one embodiment, upon transmitting the SIB1 and/or MIB/SSB request to Cell A, the UE acquires the requested SIB1 and/or MIB/SSB from Cell A. In one embodiment, the UE acquires the requested SIB1 and/or MIB/SSB upon receiving the acknowledgement of SIB1 and/or MIB/SSB request from Cell A. Cell B may inform Cell A to start transmitting SIB1 and/or a MIB/SSB upon receiving request from UE. In case of a RACH based SIB1 and/or MIB/SSB request, acknowledgement can be a Msg2 or a Msg4. The Msg2 may include a RAR for a transmitted random access preamble ID. The Msg4 may include a contention resolution MAC CE.

At step 1706, in one embodiment, upon transmitting the SIB1 and/or MIB/SSB request to Cell B, the UE acquires the requested SIB1 and/or MIB/SSB from Cell A. In one embodiment, the UE acquires the requested SIB1 and/or MIB/SSBs upon receiving the acknowledgement of SIB1 and/or MIB/SSB request from Cell B. In case of a RACH based SIB1 and/or MIB/SSB request, the acknowledgement can be Msg2 or Msg4. The Msg2 may include a RAR for the transmitted random access preamble ID. The Msg4 may include a contention resolution MAC CE.

At step 1708, upon acquiring SIB1 and/or a MIB/SSBs, the UE performs a random access procedure towards Cell A. Note that in one embodiment, the UE may only acquire SSBs of Cell A and contents of a MIB and SIB1 of Cell A may be obtained from Cell B. Note that In one embodiment, the UE may only acquire SSBs/MIB of Cell A and the contents of SIB1 of Cell A may be obtained from Cell B.

Although FIG. 17 illustrates one example UE operation to acquire SIB1 and/or a MIB/SSB 1700, various changes may be made to FIG. 17. For example, while shown as a series of steps, various steps in FIG. 17 could overlap, occur in parallel, occur in a different order, occur any number of times, be omitted, or replaced by other steps.

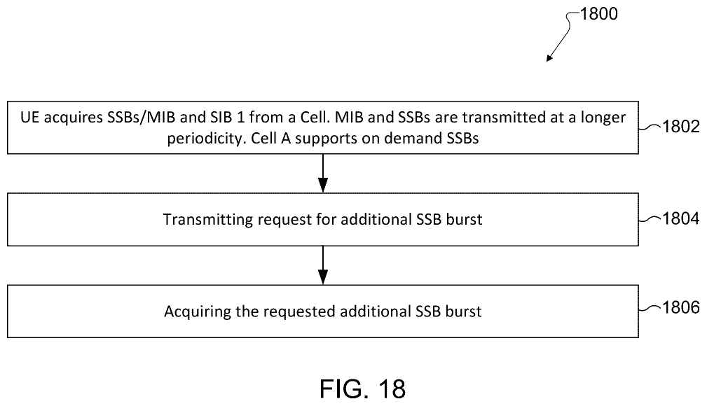

FIG. 18 illustrates an example UE operation to acquire on demand SSBs/light MIB in a cell 1800 according to embodiments of the present disclosure. An embodiment of the operation illustrated in FIG. 18 is for illustration only. One or more of the components illustrated in FIG. 18 may be implemented in specialized circuitry configured to perform the noted functions or one or more of the components may be implemented by one or more processors executing instructions to perform the noted functions. Other embodiments for a UE operation to acquire on demand SSBs/light MIB in a cell could be used without departing from the scope of this disclosure.

In the example of FIG. 18, the UE operation begins at step 1802. At step 1802, A UE acquires SSBs/MIB and SIB1 from a Cell (e.g., Cell A). The MIB and SSBs are transmitted at a longer periodicity. The periodicity (P) may be indicated in the MIB or SIB1. For fast UL access or for receiving paging or for measurements, the UE may seek to acquire an additional SSB burst in the interval (P) between two SSB bursts. SIB1 may indicate that Cell A supports on demand SSBs.

At step 1804, if Cell A supports on demand SSBs and the UE seeks to acquire an additional SSB burst in the interval (P) between two SSB bursts, the UE may transmit a request for an additional SSB burst to the network (e.g., a base station or gNB) using the additional SSB burst request configuration.

In one embodiment, the UE may transmit a PRACH preamble towards the Cell A to request for the additional SSB burst.

In one embodiment, the UE may transmit an UL low power wakeup signal towards the cell (Cell A) to request for the additional SSB burst.

In one embodiment, the UE may transmit a MsgA towards the cell (Cell A) to request for the additional SSB burst.

In one embodiment, the UE may initiate a random access procedure towards the cell (Cell A) to request for the additional SSB burst. During the random access procedure an RRC message or MAC CE may be included in a Msg3 or MsgA which indicates the request for the additional SSB burst.

In one embodiment, the UE may transmit a PRACH preamble/MsgA/UL low power wakeup signal/Msg3/Random access procedure towards another cell (Cell B) to request for the additional SSB burst.

In one embodiment, the UE may transmit a scheduling request or PUCCH towards the cell (Cell A) to request for the additional SSB burst.

In one embodiment, the request configuration (e.g., RACH configuration or UL low power wakeup signal) for transmitting the request for the additional SSB burst can be a pre-defined/default configuration.

In one embodiment, the request configuration (e.g., RACH configuration or UL low power wakeup signal) for transmitting the request for the additional SSB burst can be acquired via another cell (config can be per cell, per frequency, can be common for all cells of SI Area or RAN notification area).

In one embodiment, a MIB of cell (cell A) may indicate the cell/carrier from which to obtain the additional SSB burst request configuration of the cell (cell A).

In one embodiment, another cell (e.g., Cell B) may broadcast the additional SSB burst request configuration for a list of one or more frequencies or carriers of cells

In one embodiment, another cell (e.g., Cell B) may broadcast the additional SSB burst request configuration of one or more cells.

In one embodiment, the configuration can be valid for a specified time (e.g., based on a validity timer). The UE may start the validity timer upon acquiring the additional SSB burst request configuration. The UE uses the acquired information while the validity timer is running. Upon expiry of validity timer, the acquired information is discarded.

In one embodiment, the additional SSB burst request configuration acquired from cell B belonging to an SI area with an SI area identifier X is valid in any cell belonging to the SI area identifier X. If Cell A has the same SI area identifier as Cell B, the UE uses the additional SSB burst request configuration acquired from cell B.

In one embodiment, the additional SSB burst request configuration acquired from cell B belonging to a RAN area is valid in any cell belonging to that RAN area i.e., the RAN area to which cell B belongs. If Cell A belongs to same RAN area as Cell B, the UE uses the additional SSB burst request configuration acquired from cell B.

In one embodiment, the additional SSB burst request configuration is associated with list of one or more cells, the association is signaled, and the acquired additional SSB burst request configuration can be used in any of the associated cells.

In one embodiment, the additional SSB burst request configuration (e.g., RACH configuration or UL low power wakeup signal) for transmitting the request for the additional SSB burst can be acquired from a MIB.

In one embodiment, the additional SSB burst request configuration (e.g., RACH configuration or UL low power wakeup signal) for transmitting the request for SIB1 can be acquired from a light SIB1 or SIB1 of Cell A.

In one embodiment, for the additional SSB burst request based on a RACH, the additional SSB burst request configuration may include one or more of the following:
A list of one or more random access preambles. In one embodiment, ra-Preamble StartIndex for the SIB1 request can be included. If N SSBs are associated with a RACH occasion, where N>=1, for the i-th SSB (i=0, . . . , N-1) the preamble with preamble index=ra-PreambleStartIndex+i is used for additional SSB burst request; For N<1, the preamble with preamble index=ra-PreambleStartIndex is used for additional SSB burst request.
In one embodiment, sib1-RequestPeriod and ra-AssociationPeriodIndex can be included for the SIB1 request. Sib1-RequestPeriod can be periodicity of the additional SSB burst request in number of association periods. ra-AssociationPeriodIndex is the index of the association period in the sib1-RequestPeriod in which the UE can send the additional SSB burst request, using the preambles indicated by ra-Preamble StartIndex.
List of one or more random access occasions

In one embodiment, for the additional SSB burst request based on an uplink low power wakeup signal, the additional SSB burst request configuration may include one or more of a list of one or more LP WUS sequences, LP WUS occasions (time and/or frequency). periodicity etc.

In one embodiment, for the additional SSB burst request based on a PUCCH, the SIB1 request configuration may include one or more of a list of one or more PUCCH resources, an SR configuration for additional SSB burst request, etc.

At step 1806, upon transmitting the additional SSB burst request, the UE acquires the additional SSB burst. In one embodiment, the UE acquires the additional SSB burst upon receiving an acknowledgement of the additional SSB burst request from the network. In case of a RACH based additional SSB burst request, the acknowledgement can be a Msg2 or Msg4. The Msg2 may include a RAR for transmitted random access preamble ID. The Msg4 may include a contention resolution MAC CE.

In one embodiment, for acquiring the requested additional SSB burst, UE monitors a monitoring window. The length of the monitoring window and start of monitoring window can be configurable. The monitoring window can start at an offset from the end of the occasion in which the additional SSB burst request is transmitted. The monitoring window can start at an offset from the end of the occasion in which an acknowledgment for the additional SSB burst request is received.

In one embodiment, for acquiring the requested additional SSB burst, the additional SSB burst location can be pre-defined and the UE monitors the earliest occasion at an offset from the end of the occasion in which the additional SSB burst request is transmitted or the earliest occasion at an offset from the end of the occasion in which an acknowledgment for the additional SSB burst request is received.

In one embodiment, for acquiring the requested additional SSB burst, the additional SSB burst location can be pre-defined and the UE monitors the earliest occasion from the end of the occasion in which the additional SSB burst request is transmitted or the earliest occasion from the end of occasion in which an acknowledgment for the additional SSB burst request is received.

Although FIG. 18 illustrates one example UE operation to acquire on demand SSBs/light MIB in a cell 1800, various changes may be made to FIG. 18. For example, while shown as a series of steps, various steps in FIG. 18 could overlap, occur in parallel, occur in a different order, occur any number of times, be omitted, or replaced by other steps.

For a UE in an RRC_CONNECTED state and receiving data of an MBS multicast session, if there is temporarily no data to be sent to the UEs for the multicast session that is active, the gNB may move the UE to an RRC_INACTIVE state by sending an RRCRelease message with a suspend configuration. If the MBS multicast session is deactivated, the gNB may move the UE to an RRC_IDLE state by sending an RRCRelease message without a suspend configuration or to an RRC_INACTIVE state by sending an RRCRelease message with a suspend configuration.

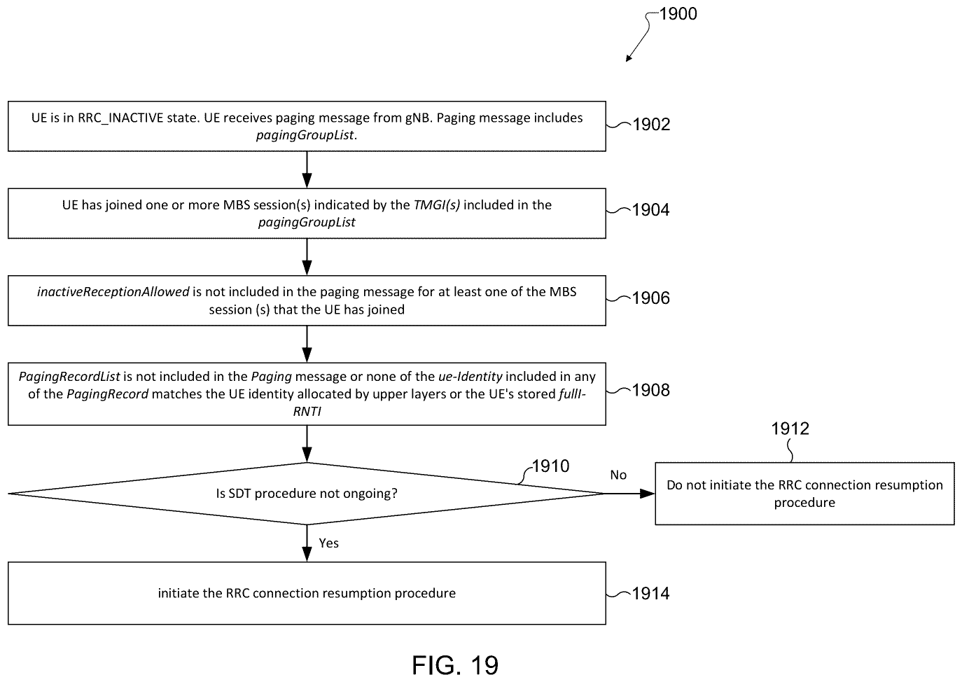

FIG. 19 illustrates an example UE operation for RRC connection resumption 1900 according to embodiments of the present disclosure. An embodiment of the operation illustrated in FIG. 19 is for illustration only. One or more of the components illustrated in FIG. 19 may be implemented in specialized circuitry configured to perform the noted functions or one or more of the components may be implemented by one or more processors executing instructions to perform the noted functions. Other embodiments for a UE operation for RRC connection resumption could be used without departing from the scope of this disclosure.

In the example of FIG. 19, the UE operation begins at step 1902. At step 1902, a UE is in an RRC_CONNECTED state. The UE receives a paging message from a gNB. The paging message includes pagingGroupList. pagingGroupList includes one or more Temporary Mobile Group Identities (TMGI[s]). For each TMGI, pagingGroupList may further indicate if reception in an RRC_INACTIVE state is allowed (reception in an RRC_INACTIVE state is allowed for a TMGI if inactive ReceptionAllowed is included and set to TRUE for that TMGI).

If the UE is in an RRC_INACTIVE and the UE has joined one or more MBS session(s) indicated by the TMGI(s) included in the pagingGroupList (step 1904); and if SDT procedure is not ongoing (step 1910); and if the UE is not configured with multicast reception in RRC_INACTIVE or if inactiveReceptionAllowed is not included for at least one of the MBS session(s) that the UE has joined (step 1906); and if PagingRecordList is not included in the Paging message or if none of the ue-Identity included in any of the PagingRecord matches the UE identity allocated by upper layers or the UE's stored fullI-RNTI (step 1908): at step 1914, the UE initiates the RRC connection resumption procedure with resumeCause set as follows:

If the UE is configured by upper layers with Access Identity 1: resumeCause is set to mps-Priority Access. Otherwise, if the UE is configured by upper layers with Access Identity 2: resumeCause is set to mcs-Priority Access. Otherwise, if the UE is configured by upper layers with one or more Access Identities equal to 11-15: resumeCause is set to highPriorityAccess. Otherwise, resumeCause is set to mt-Access.

If UE is in RRC_INACTIVE and the UE has joined one or more MBS session(s) indicated by the TMGI(s) included in the pagingGroupList (step 1904); and if SDT procedure is ongoing (step 1910); and if the UE is not configured with multicast reception in RRC_INACTIVE or if inactive ReceptionAllowed is not included for at least one of the MBS session(s) that the UE has joined (step 1906); and if PagingRecordList is not included in the Paging message or if none of the ue-Identity included in any of the PagingRecord matches the UE identity allocated by upper layers or the UE's stored fullI-RNT (step1908) I: at step 1912 the UE does not initiate the RRC connection resumption procedure.

If the UE is in an RRC_INACTIVE state and the UE has joined one or more MBS session(s) indicated by the TMGI(s) included in the pagingGroupList; and if the UE is configured with multicast reception in an RRC_INACTIVE state and if inactive ReceptionAllowed is included for at least one of the MBS session(s) that the UE has joined: the UE stays in the RRC_INACTIVE and starts monitoring the G-RNTI(s) corresponding to the TMGI(s).

In one embodiment, the operation of UE is as follows:

If the UE is in an RRC_INACTIVE and the UE has joined one or more MBS session(s) indicated by the TMGI(s) included in the pagingGroupList; and if SDT procedure is not ongoing; and if the UE is not configured with multicast reception in RRC_INACTIVE or if inactiveReceptionAllowed is not included for at least one of the MBS session(s) that the UE has joined; and if PagingRecordList is not included in the Paging message or if none of the ue-Identity included in any of the PagingRecord matches the UE identity allocated by upper layers or the UE's stored fullI-RNTI: the UE initiates the RRC connection resumption procedure with resumeCause set as follows:

If the UE is configured by upper layers with Access Identity 1: resumeCause is set to mps-Priority Access. Otherwise, if the UE is configured by upper layers with Access Identity 2: resumeCause is set to mcs-Priority Access. Otherwise, if the UE is configured by upper layers with one or more Access Identities equal to 11-15: resumeCause is set to highPriority Access. Otherwise, resumeCause is set to mt-Access.

Otherwise, if the ue-Identity included in any of the PagingRecord matches the UE identity allocated by upper layers: the UE forwards the TMGI(s) to the upper layers;

Otherwise, if the UE is configured with multicast reception in an RRC_INACTIVE state and if inactive ReceptionAllowed is included for at least one of the MBS session(s) that the UE has joined: the UE stays in the RRC_INACTIVE state and starts monitoring the G-RNTI(s) corresponding to the TMGI(s);

Although FIG. 19 illustrates another example UE operation for RRC connection resumption 1900, various changes may be made to FIG. 19. For example, while shown as a series of steps, various steps in FIG. 19 could overlap, occur in parallel, occur in a different order, occur any number of times, be omitted, or replaced by other steps.

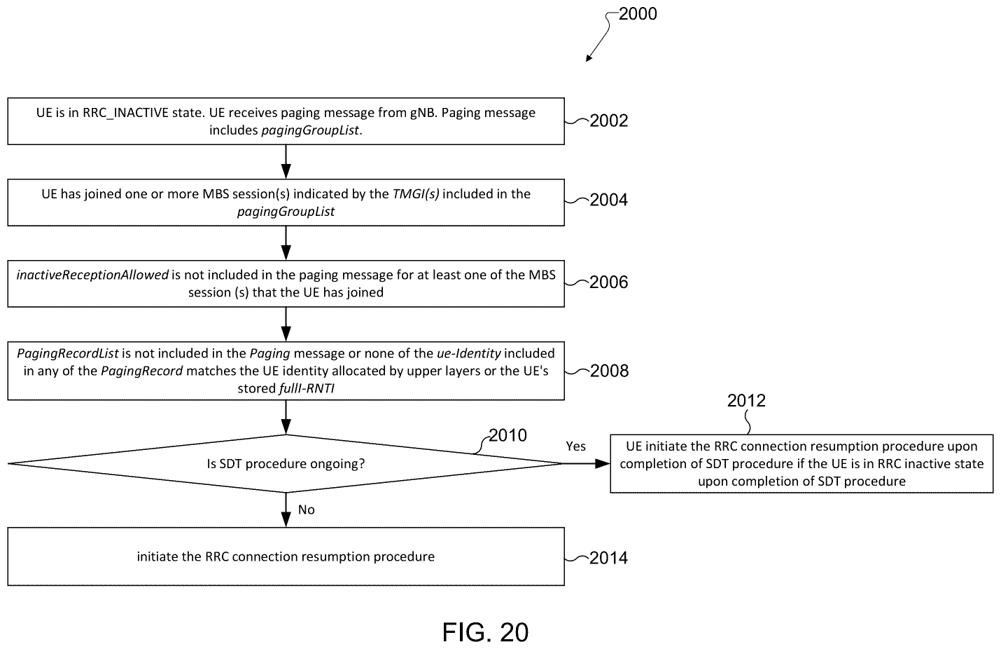

FIG. 20 illustrates another example UE operation for RRC connection resumption 2000 according to embodiments of the present disclosure. An embodiment of the operation illustrated in FIG. 20 is for illustration only. One or more of the components illustrated in FIG. 20 may be implemented in specialized circuitry configured to perform the noted functions or one or more of the components may be implemented by one or more processors executing instructions to perform the noted functions. Other embodiments for a UE operation for RRC connection resumption could be used without departing from the scope of this disclosure.

In the example of FIG. 20, the UE operation begins at step 2002. At step 2002, a is in an RRC_CONNECTED state. The UE receives a paging message from a gNB. The paging message includes pagingGroupList. pagingGroupList includes one or more TMGI(s). For each TMGI, pagingGroupList may further indicate if reception in an RRC_INACTIVE state is allowed (reception in an RRC_INACTIVE state is allowed for a TMGI if inactiveReceptionAllowed is included and set to TRUE for that TMGI).

If the UE is in an RRC_INACTIVE state and the UE has joined one or more MBS session(s) indicated by the TMGI(s) included in the pagingGroupList (step 2002); and if SDT procedure is not ongoing (step 2010); and if the UE is not configured with a multicast reception in an RRC_INACTIVE state or if inactiveReceptionAllowed is not included for at least one of the MBS session(s) that the UE has joined (step 2006); and if PagingRecordList is not included in the Paging message or if none of the ue-Identity included in any of the PagingRecord matches the UE identity allocated by upper layers or the UE's stored fullI-RNTI (step 2008): The UE initiate the RRC connection resumption procedure with resumeCause set as follows:

If the UE is configured by upper layers with Access Identity 1: resumeCause is set to mps-Priority Access. Otherwise, if the UE is configured by upper layers with Access Identity 2: resumeCause is set to mcs-Priority Access. Otherwise, if the UE is configured by upper layers with one or more Access Identities equal to 11-15: resumeCause is set to highPriority Access. Otherwise, else: resumeCause is set to mt-Access.

If the UE is in an RRC_INACTIVE state and the UE has joined one or more MBS session(s) indicated by the TMGI(s) included in the pagingGroupList (step 2002); and if SDT procedure is ongoing (step 2010); and if the UE is not configured with multicast reception in RRC_INACTIVE or if inactiveReceptionAllowed is not included for at least one of the MBS session(s) that the UE has joined (step 2006); and if PagingRecordList is not included in the Paging message or if none of the ue-Identity included in any of the PagingRecord matches the UE identity allocated by upper layers or the UE's stored fullI-RNTI (step 2008): at step 2012 The UE initiates the RRC connection resumption procedure with resumeCause set as follows when the ongoing SDT procedure is completed (or successfully completed), if the UE is in an RRC inactive state upon completion of SDT procedure:

If the UE is configured by upper layers with Access Identity 1: resumeCause is set to mps-Priority Access. Otherwise, if the UE is configured by upper layers with Access Identity 2: resumeCause is set to mcs-Priority Access. Otherwise, if the UE is configured by upper layers with one or more Access Identities equal to 11-15: resumeCause is set to highPriority Access. Otherwise, resumeCause is set to mt-Access.

In one embodiment, the UE initiates the RRC connection setup procedure when the ongoing SDT procedure is completed (or unsuccessfully completed), if the UE is in an RRC IDLE state upon completion of SDT procedure.

If the UE is in an RRC_INACTIVE state and the UE has joined one or more MBS session(s) indicated by the TMGI(s) included in the pagingGroupList; and if the UE is configured with multicast reception in RRC_INACTIVE and if inactiveReceptionAllowed is included for at least one of the MBS session(s) that the UE has joined: the UE stays in the RRC_INACTIVE state and starts monitoring the G-RNTI(s) corresponding to the TMGI(s).

If the UE is in an RRC_INACTIVE and the UE has joined one or more MBS session(s) indicated by the TMGI(s) included in the pagingGroupList; and if SDT procedure is not ongoing; and if the UE is not configured with multicast reception in RRC_INACTIVE or if inactiveReceptionAllowed is not included for at least one of the MBS session(s) that the UE has joined; and if PagingRecordList is not included in the Paging message or if none of the ue-Identity included in any of the PagingRecord matches the UE identity allocated by upper layers or the UE's stored fullI-RNTI: the UE initiates the RRC connection resumption procedure with resumeCause set as follows:

If the UE is configured by upper layers with Access Identity 1: resumeCause is set to mps-Priority Access. Otherwise, if the UE is configured by upper layers with Access Identity 2: resumeCause is set to mcs-Priority Access. Otherwise, if the UE is configured by upper layers with one or more Access Identities equal to 11-15: resumeCause is set to highPriority Access. Otherwise, resumeCause is set to mt-Access.

Otherwise, if the SDT procedure is ongoing, the UE initiates the RRC connection resumption procedure with resumeCause set as follows upon completion of the SDT procedure, if the UE is still in the RRC inactive state:

If the UE is configured by upper layers with Access Identity 1: resumeCause is set to mps-Priority Access. Otherwise, if the UE is configured by upper layers with Access Identity 2: resumeCause is set to mcs-Priority Access. Otherwise, if the UE is configured by upper layers with one or more Access Identities equal to 11-15: resumeCause is set to highPriorityAccess. Otherwise, resumeCause is set to mt-Access.

Although FIG. 20 illustrates another example UE operation for RRC connection resumption 2000, various changes may be made to FIG. 20. For example, while shown as a series of steps, various steps in FIG. 20 could overlap, occur in parallel, occur in a different order, occur any number of times, be omitted, or replaced by other steps.

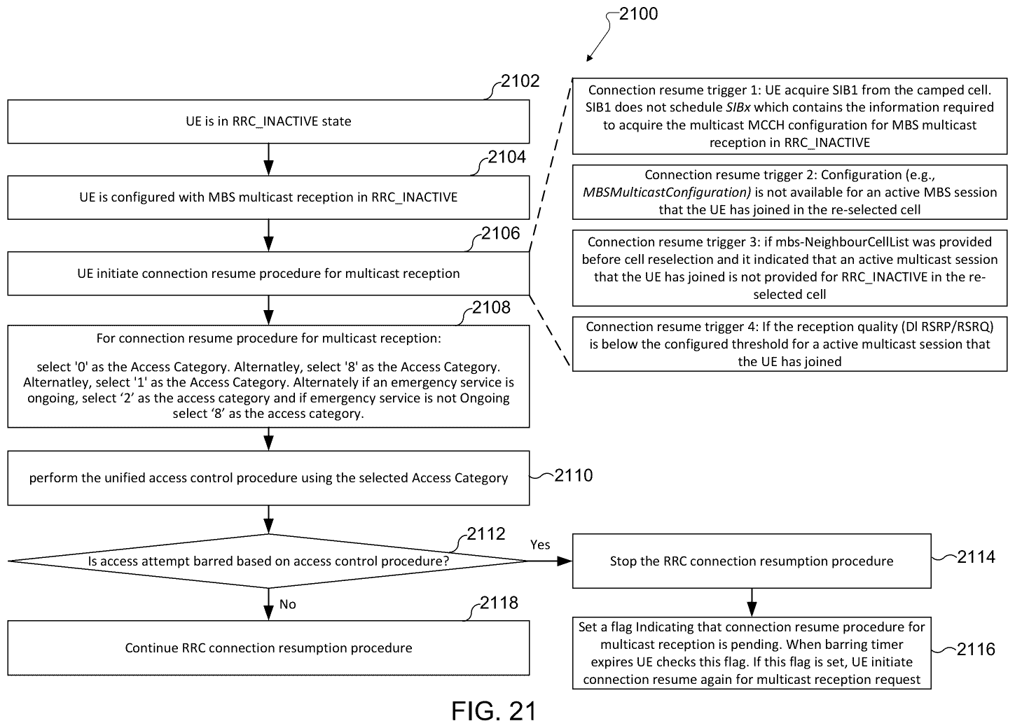

FIG. 21 illustrates another example UE operation for RRC connection resumption 2100 according to embodiments of the present disclosure. An embodiment of the operation illustrated in FIG. 21 is for illustration only. One or more of the components illustrated in FIG. 21 may be implemented in specialized circuitry configured to perform the noted functions or one or more of the components may be implemented by one or more processors executing instructions to perform the noted functions. Other embodiments for a UE operation for RRC connection resumption could be used without departing from the scope of this disclosure.

In the example of FIG. 21, the UE operation begins at step 2102. At step 2102, A UE is in an RRC_INACTIVE state. At step 2104, the UE is configured with MBS multicast reception in RRC_INACTIVE.

At step 2106, the UE initiate a connection resume procedure for multicast reception. The trigger for initiating the connection resume procedure for multicast reception can be as follows:
Connection resume trigger 1: the UE acquires SIB1 from the camped cell. SIB1 does not schedule SIBx which contains the information used to acquire the multicast MCCH configuration for MBS multicast reception in an RRC_INACTIVE state.
Connection resume trigger 2: the configuration (e.g., MBSMulticastConfiguration) is not available for an active MBS session that the UE has joined in the re-selected cell.
Connection resume trigger 3: if mbs-NeighbourCellList was provided before cell reselection and it indicated that an active multicast session that the UE has joined is not provided for the RRC_INACTIVE state in the re-selected cell
Connection resume trigger 4: if the reception quality (D1 RSRP/RSRQ) is below the configured threshold for an active multicast session that the UE has joined.

At step 2108, for the connection resume procedure for multicast reception:

In one embodiment, the UE selects ‘0’ as the Access Category. In one embodiment, the UE selects ‘8’ as the Access Category. In one embodiment the UE selects ‘1’ as the Access Category. In one embodiment if an emergency service is ongoing, the UE selects ‘2’ as the access category and if emergency service is not ongoing UE selects ‘8’ as the access category. In one embodiment, the access category for the connection resume procedure for multicast reception multicast reception can be signaled in an RRC Release/SIB or can be pre-defined.

At step 2110, the UE performs the unified access control procedure using the selected Access Category.

At step 2112, the UE checks if the access attempt is barred based on an access control procedure.

At step 2114, if the access attempt is barred based on access control procedure UE may perform the following:

The UE stops the RRC connection resumption procedure. In one embodiment, upon expiry of barring timer, the UE initiates a connection resume again for multicast reception request if the UE is still in an RRC_INACTIVE state. In one embodiment, upon expiry of a barring timer, the UE initiates a connection resume again for a multicast reception request.

At step 2116, in one embodiment, the UE sets a flag indicating that the connection resume procedure for multicast reception is pending. When the barring timer expires the UE checks this flag. If the flag is set, the UE initiates a connection resume again for the multicast reception request. Otherwise, if the flag is set, and condition(s) to initiate connection resume are still valid, the UE initiates a connection resume again for the multicast reception request.

Otherwise, at step 2118, if the access attempt is not barred based on access control procedure: the UE continues the RRC connection resumption procedure.

Although FIG. 21 illustrates another example UE operation for RRC connection resumption 2100, various changes may be made to FIG. 21. For example, while shown as a series of steps, various steps in FIG. 21 could overlap, occur in parallel, occur in a different order, occur any number of times, be omitted, or replaced by other steps.

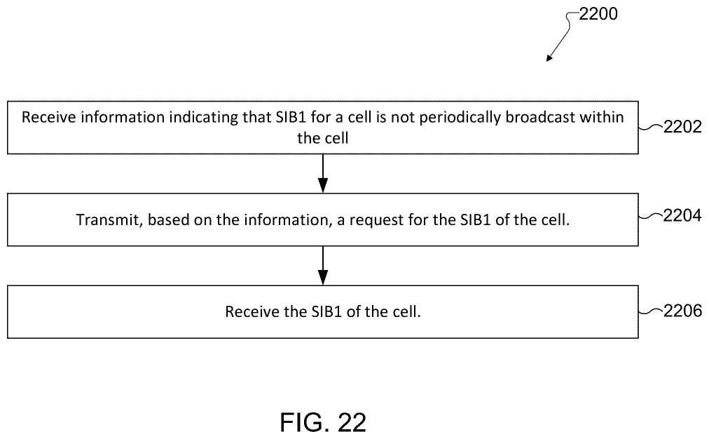

FIG. 22 illustrates an example method for acquisition of system information 2200 according to embodiments of the present disclosure. An embodiment of the method illustrated in FIG. 22 is for illustration only. One or more of the components illustrated in FIG. 22 may be implemented in specialized circuitry configured to perform the noted functions or one or more of the components may be implemented by one or more processors executing instructions to perform the noted functions. Other embodiments for a method for acquisition of system information could be used without departing from the scope of this disclosure.

The method of FIG. 22 begins at step 2202. At step 2202, a UE receives information indicating that SIB1 for a cell is not periodically broadcast within the cell.

At step 2204, the UE transmits, based on the information, a request for the SIB1 of the cell. Finally, at step 2206, the UE receives the SIB1 of the cell.

Although FIG. 22 illustrates one example of a method for acquisition of system information 2200, various changes may be made to FIG. 22. For example, while shown as a series of steps, various steps in FIG. 22 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a processor; and
a transceiver operatively coupled to the processor, the transceiver configured to:
receive information indicating that a system information block 1 (SIB1) for a cell is not periodically broadcast within the cell;
transmit, based on the information, a request for the SIB1 of the cell; and
receive the SIB1 of the cell.

2. The UE of claim 1, wherein to receive the information indicating that the SIB1 for the cell is not periodically broadcast within the cell, the transceiver is further configured to receive at least one of:
a master information block (MIB) of the cell indicating that the SIB1 is not periodically broadcast;
a payload of a physical broadcast channel (PBCH) of the cell indicating that the SIB1 is not periodically broadcast;
downlink control information (DCI) of a physical downlink common control channel (PDCCH) of the cell indicating that the SIB1 is not periodically broadcast;
information indicating a list of cells or carrier frequencies of cells not periodically broadcasting the SIB1;
a SIB1 request configuration;
a synchronization signal block (SSB) in at least one resource associated with on demand SIB1 transmission;
a primary synchronization signal (PSS)/secondary synchronization signal (SSS) sequence associated with on demand SIB1 transmission;
a radio resource control (RRC) message including a list of cells or carrier frequencies of cells not periodically broadcasting SIB1; and
information indicating that the cell is an access cell.

3. The UE of claim 1, wherein to transmit the request for the SIB1 of the cell, the transceiver is further configured to transmit, to the cell or another cell, at least one of:
as part of a random access (RA) procedure, a message indicating the request for the SIB1 of the cell;
as part of a random access (RA) procedure, a PRACH preamble indicating the request for the SIB1 of the cell;
a low power wakeup signal (LP WUS) indicating the request for the SIB1 of the cell; and
a scheduling request indicating the request for the SIB1 of the cell.

4. The UE of claim 1, wherein:
the transceiver is further configured to:
receive, from the cell or another cell, a first SIB1 request configuration; and
transmit the request for the SIB1 of the cell based on the receipt of the first SIB1 request configuration; and
the processor is configured to:
start a validity timer upon receiving the first SIB1 request configuration; and
discard the first SIB1 request configuration upon expiry of the validity timer.

5. The UE of claim 4, wherein to receive the first SIB1 request configuration, the transceiver is further configured to receive, from the cell or the other cell, a configuration for at least one of:
a random access (RA) procedure for the request for the SIB1 of the cell;
a low power wakeup signal (LP WUS) for the request for the SIB1 of the cell; and
a PUCCH configuration for the request for the SIB1 of the cell.

6. The UE of claim 4, wherein the first SIB1 request configuration, when received from the other cell includes at least one of:
a per cell configuration for the SIB1 request;
a per frequency configuration for the SIB1 request;
a configuration for the SIB1 request applicable for all cells of a system information (SI) area; and
a configuration for the SIB1 request applicable for all cells of a radio access network (RAN) notification area.

7. The UE of claim 4, wherein:
the transceiver is further configured to receive a second SIB1 request configuration,
the first SIB1 request configuration is associated with a first system information (SI) area identifier
the second SIB1 request configuration is associated with a second SI area identifier; and
to transmit the request for the SIB1 of the cell:
the processor is further configured to determine whether the first SI area identifier or the second SI area identifier corresponds with the cell; and
the transceiver is further configured to apply, based on the determination, the first or the second SIB1 request configuration to transmit the request for the SIB1 of the cell.

8. The UE of claim 1, wherein the transceiver is further configured to receive the requested SIB1 in a monitoring window that starts at one of:
an offset from an end of an occasion in which the request for the SIB1 of the cell is transmitted;
a first PDCCH monitoring occasion that is at least one symbol away from the end of the occasion in which the request for the SIB1 of the cell is transmitted;
an offset from an end of an occasion in which an acknowledgement for the request for the SIB1 of the cell is received; and
a first PDCCH monitoring occasion that is at least one symbol away from the end of the occasion in which the acknowledgement for the request for the SIB1 of the cell is received.

9. A base station (BS) comprising:
a processor; and
a transceiver operatively coupled to the processor, the transceiver configured to:
transmit information indicating that a system information block 1 (SIB1) for a cell is not periodically broadcast within the cell;
receive a request for the SIB1 of the cell; and
transmit the SIB1 of the cell.

10. The BS of claim 9, wherein to transmit the information indicating that the SIB1 for the cell is not periodically broadcast within the cell, the transceiver is further configured to transmit at least one of:
a master information block (MIB) of the cell indicating that the SIB1 is not periodically broadcast;
a payload of a physical broadcast channel (PBCH) of the cell indicating that the SIB1 is not periodically broadcast;
downlink control information (DCI) of a physical downlink common control channel (PDCCH) of the cell indicating that the SIB1 is not periodically broadcast;
information indicating a list of cells or carrier frequencies of cells not periodically broadcasting the SIB1;
a SIB1 request configuration;
a synchronization signal block (SSB) in at least one resource associated with on demand SIB1 transmission;
a primary synchronization signal (PSS)/secondary synchronization signal (SSS) sequence associated with on demand SIB1 transmission;
a radio resource control (RRC) message including a list of cells or carrier frequencies of cells not periodically broadcasting SIB1; and
information indicating that the cell is an access cell.

11. The BS of claim 9, wherein to receive the request for the SIB1 of the cell, the transceiver is further configured to receive at least one of:
as part of a random access (RA) procedure, a message indicating the request for the SIB1 of the cell;
as part of a random access (RA) procedure, a PRACH preamble indicating the request for the SIB1 of the cell;
a low power wakeup signal (LP WUS) indicating the request for the SIB1 of the cell; and
a scheduling request indicating the request for the SIB1 of the cell.

12. The BS of claim 9, wherein the transceiver is further configured to transmit the requested SIB1 in a monitoring window that starts at one of:
an offset from an end of an occasion in which the request for the SIB1 of the cell is transmitted;
a first PDCCH monitoring occasion that is at least one symbol away from the end of the occasion in which the request for the SIB1 of the cell is transmitted;
an offset from an end of an occasion in which an acknowledgement for the request for the SIB1 of the cell is received; and
a first PDCCH monitoring occasion that is at least one symbol away from the end of the occasion in which the acknowledgement for the request for the SIB1 of the cell is received.

13. A method of operating a user equipment (UE), the method comprising:
receiving information indicating that a system information block 1 (SIB1) for a cell is not periodically broadcast within the cell;
transmitting, based on the information, a request for the SIB1 of the cell; and
receiving the SIB1 of the cell.

14. The method of claim 13, wherein receiving the information indicating that the SIB1 for the cell is not periodically broadcast within the cell comprises receiving at least one of:
a master information block (MIB) of the cell indicating that the SIB1 is not periodically broadcast;
a payload of a physical broadcast channel (PBCH) of the cell indicating that the SIB1 is not periodically broadcast;
downlink control information (DCI) of a physical downlink common control channel (PDCCH) of the cell indicating that the SIB1 is not periodically broadcast;
information indicating a list of cells or carrier frequencies of cells not periodically broadcasting the SIB1;
a SIB1 request configuration;
a synchronization signal block (SSB) in at least one resource associated with on demand SIB1 transmission;
a primary synchronization signal (PSS)/secondary synchronization signal (SSS) sequence associated with on demand SIB1 transmission;
a radio resource control (RRC) message including a list of cells or carrier frequencies of cells not periodically broadcasting SIB1; and
information indicating that the cell is an access cell.

15. The method of claim 13, wherein transmitting the request for the SIB1 of the cell comprises transmitting, to the cell or another cell, at least one of:
as part of a random access (RA) procedure, a message indicating the request for the SIB1 of the cell;
as part of a random access (RA) procedure, a PRACH preamble indicating the request for the SIB1 of the cell;
a low power wakeup signal (LP WUS) indicating the request for the SIB1 of the cell; and
a scheduling request indicating the request for the SIB1 of the cell.

16. The method of claim 13, further comprising:
receiving, from the cell or another cell, a first SIB1 request configuration; and
transmitting the request for the SIB1 of the cell based on the receipt of the first SIB1 request configuration;
starting a validity timer upon receiving the first SIB1 request configuration; and
discarding the first SIB1 request configuration upon expiry of the validity timer.

17. The method of claim 16, wherein receiving the first SIB1 request configuration comprises receiving, from the cell or the other cell, a configuration for at least one of:
a random access (RA) procedure for the request for the SIB1 of the cell;
a low power wakeup signal (LP WUS) for the request for the SIB1 of the cell; and
a PUCCH configuration for the request for the SIB1 of the cell.

18. The method of claim 16, wherein the first SIB1 request configuration, when received from the other cell includes at least one of:
a per cell configuration for the SIB1 request;
a per frequency configuration for the SIB1 request;
a configuration for the SIB1 request applicable for all cells of a system information (SI) area; and
a configuration for the SIB1 request applicable for all cells of a radio access network (RAN) notification area.

19. The method of claim 16, wherein:
the method further includes receiving a second SIB1 request configuration,
the first SIB1 request configuration is associated with a first system information (SI) area identifier
the second SIB1 request configuration is associated with a second SI area identifier; and
transmitting the request for the SIB1 of the cell comprises:
determining whether the first SI area identifier or the second SI area identifier corresponds with the cell; and
applying, based on the determination, the first or the second SIB1 request configuration to transmit the request for the SIB1 of the cell.

20. The method of claim 13, further comprising receiving the requested SIB1 in a monitoring window that starts at one of:
an offset from an end of an occasion in which the request for the SIB1 of the cell is transmitted;
a first PDCCH monitoring occasion that is at least one symbol away from the end of the occasion in which the request for the SIB1 of the cell is transmitted;
an offset from an end of an occasion in which an acknowledgement for the request for the SIB1 of the cell is received; and
a first PDCCH monitoring occasion that is at least one symbol away from the end of the occasion in which the acknowledgement for the request for the SIB1 of the cell is received.
